(19) United States
(12) Patent Application Publication
(10) Pub. No.: US 2009/0300570 A1
(43) Pub. Date: Dec. 3, 2009

(54) INTERACTIVE HIERARCHICAL ANALOG LAYOUT SYNTHESIS FOR INTEGRATED CIRCUITS

(75) Inventor: Shufan Chan, Costa Mesa, CA (US)

Correspondence Address: Alford Law Group, Inc., 23052H Alicia Parkway, Suite 201, Mission Viejo, CA, 92692, US

(73) Assignee: SYNCIRA CORPORATION, Cerritos, CA (US)

(21) Appl. No.: 12/307,562

(22) PCT Filed: Jul. 16, 2007
(86) PCT No.: PCT/US2007/073640

§ 371 Date: Jan. 5, 2009

Related U.S. Application Data
(63) Continuation-in-part of application No. 11/757,349, filed on Jun. 2, 2007.
(60) Provisional application No. 60/831,613, filed on Jul. 17, 2006.
(60) Provisional application No. 60/941,636, filed on Jun. 1, 2007.

(51) Int. Cl. G06F 17/50

(52) U.S. Cl. 716/11; 716/18

(57) ABSTRACT

In one embodiment of the invention, a method of synthesizing a layout of an integrated circuit chip including analog circuitry is disclosed. The method includes receiving a circuit netlist of an integrated circuit chip including analog circuitry; representing and manipulating a hierarchical analog circuit layout including device placement and net routing in response to the circuit netlist, the hierarchical analog circuit layout including a plurality of levels of layout hierarchy; and passing layout information from one level of the layout hierarchy to an adjacent level of the layout hierarchy to synthesize the layout of the integrated circuit chip. In response to user preference directives, methods and apparatus are disclosed to perform re-synthesis of analog circuit layouts in another embodiment of the invention.

### CROSS REFERENCE TO RELATED APPLICATIONS

This patent application is a U.S. national application and claims the benefit of international patent application No. PCT/US07/73640 entitled INTERACTIVE HIERARCHICAL ANALOG LAYOUT SYNTHESIS FOR INTEGRATED CIRCUITS filed by Shufan Chan on 16 Jul. 2007; and is a continuation-in-part and claims the benefit of U.S. Non-Provisional patent application Ser. No. 11/757,349 entitled HIERARCHICAL ANALOG LAYOUT SYNTHESIS AND OPTIMIZATION FOR INTEGRATED CIRCUITS filed on 2 Jun. 2007 by inventor Shufan Chan. International patent application No. PCT/US07/73640 claims the benefit of U.S. Provisional Patent Application No. 60/831,613 entitled HIERARCHICAL ANALOG LAYOUT SYNTHESIS AND OPTIMIZATION FOR INTEGRATED CIRCUITS filed on 17 Jul. 2006 by inventor Shufan Chan; U.S. Provisional Patent Application No. 60/941,636 entitled INTERACTIVE ANALOG LAYOUT SYNTHESIS FOR INTEGRATED CIRCUITS filed on 1 Jun. 2007 by inventor Shufan Chan; and U.S. Non-Provisional patent application Ser. No. 11/757,349 entitled HIERARCHICAL ANALOG LAYOUT SYNTHESIS AND OPTIMIZATION FOR INTEGRATED CIRCUITS filed on 2 Jun. 2007 by inventor Shufan Chan.

### FIELD

The embodiments of the invention relate generally to interactive layout software for integrated circuits. More particularly, the embodiments of the invention relate to interactive software tools for automated layout synthesis of analog circuitry for integrated circuits.

### BACKGROUND

Analog circuit design differs from digital circuit design. Digital circuits prefer operating with binary numbers, a logical one or logical zero, represented by a pair of voltage levels—a logical high voltage level and a logical low voltage level or a digital signal. That is, a digital integrated circuit operates with discrete (binary) signals. The voltage levels between the logical high voltage level and the logical low voltage level were typically considered to be noise and usually unwanted in digital circuits. A digital integrated circuit typically utilizes the capabilities of Boolean logic gates to perform functions. Thus, the performance of a digital integrated circuit is less sensitive to placement, orientation, and the physical structure of transistor switches.

In contrast, analog circuitry operates using an analog signal over a range of voltages of an analog signal that can be between a maximum level and a minimum level. That is, an analog integrated circuit is an IC that operates with inter-module communication signals that are continuous rather than discrete. An analog integrated circuit has analog circuitry that exploits and utilizes the full spectrum of capabilities exhibited by individual low-level components, such as transistors, diodes, resistors, capacitors and inductors. The performance of an analog integrated circuit is very sensitive to the layout (placement, orientation, and physical pattern) of its low-level components. For example, noise immunity of an analog circuit and isolation of digital circuits from analog circuits can be important in the layout of analog circuitry.

Traditionally, analog circuitry has been manually laid out into its semiconductor mask layers for semiconductor manufacturing. This is because a human layout designer typically was experienced in analog circuit layout with prior knowledge, experience, and skill as to how the devices in an analog circuit were laid out so as to provide better performance and/or better noise immunity. The human layout designer can make some choices up front prior to laying out the analog circuitry. However, the number of choices that can be made up-front prior to layout by a human layout designer are limited. Moreover, a human layout designer requires considerable time to layout an entire analog circuit chip or an entire mixed signal chip with both analog and digital circuitry.

It is desirable to speed up the process of generating a layout for analog circuitry so that iterations may be made to find a user preferred solution.

### BRIEF DESCRIPTIONS OF THE DRAWINGS

FIG. 1 is an integrated circuit including an analog circuit portion upon which embodiments of the invention may operate.

FIG. 2 is an exemplary diagram of circuit hierarchy of an integrated circuit chip upon which embodiments of the invention may operate.

FIG. 3 is a functional block diagram of a hierarchical analog layout synthesis tool and system.

FIG. 4 is a flow chart diagram of analog circuit synthesis design flow including the synthesizing the circuit layout by the system and tool of FIG. 3.

FIG. 5 is a system flow chart diagram of the hierarchical analog layout synthesis and optimization performed by the system and tool of FIG. 3.

FIG. 6A is a more detailed flow chart diagram of the analog layout synthesis and analog layout optimization performed by the system and tool of FIG. 3.

FIG. 6B is a more detailed flow chart diagram of analog layout synthesis and analog layout optimization performed by the system and tool of FIG. 3 to support iterative layout generation to find a user preferred solution.

FIG. 7A is a flow chart diagram of an implementation of a multi-objective evolutionary algorithm (MOEA) performed by the system and tool of FIG. 3.

FIG. 7B is a flow chart diagram of an implementation of a multi-objective optimization algorithm (MOOA) performed by the system and tool of FIG. 3.

FIG. 8 is a flow chart diagram of the analog layout routing performed by the system and tool of FIG. 3.

FIG. 9A is a displayed user interface on a monitor of a computer system for layout selection.

FIG. 9B is a displayed user interface on a monitor of a computer system for with a window for a user to write directives for re-synthesis.

FIG. 10A illustrates a multiple dimension plot for layout selection by a user that may be displayed on a monitor within a plot window of FIG. 9A.

FIG. 10B illustrates a plurality of two dimension plots for layout selection by a user that may be displayed on a monitor within a plot window of FIG. 9A.

FIG. 11 illustrates an exemplary schematic diagram of an comparator to explain the plurality of layout choices that are made available to a user.

FIG. 12 illustrates an exemplary shape curve of a family of layout solutions made available by the embodiments of the invention for the schematic diagram of the comparator of FIG. 11.

FIGS. 13A-13C illustrate three exemplary floor-plans made available by the embodiments of the invention for the schematic diagram of the comparator of FIG. 11.

FIGS. 14A-14C illustrate three exemplary layouts out of one hundred-fifty that are made available by the embodiments of the invention for the same circuit of a filter network.

FIG. 15 illustrates an exemplary embodiment of a computing system usable with embodiments of the invention.

FIG. 16A illustrates an exemplary layout floorplan for an integrated circuit.

FIG. 16B illustrates an exemplary slicing tree representation for the layout floorplan of FIG. 16A.

FIG. 16C illustrates an exemplary polish expression representation of the layout floorplan of FIG. 16A.

FIG. 17 illustrates a user transaction diagram for interactive analog layout synthesis.

FIG. 18A illustrates an exemplary layout for an analog circuit represented by one or more bins.

FIG. 18B illustrates an exemplary polish expression using bins as operands in the representation of the layout of FIG. 18A.

FIGS. 19A-19B illustrate directives that may be specified by a user.

FIGS. 20A-20C illustrate iterations of analog synthesis runs of the same analog circuit with varying user preferences.

FIG. 21 illustrates a flow chart of a method of preparing for re-synthesis of an analog circuit layout.

### DETAILED DESCRIPTION

In the following detailed description of the embodiments of the invention, numerous specific details are set forth in order to provide a thorough understanding of the present invention. However, it will be obvious to one skilled in the art that the embodiments of the invention may be practiced without these specific details. In other instances well known methods, procedures, components, and circuits have not been described in detail so as not to unnecessarily obscure aspects of the embodiments of the invention.

### Introduction to Interactive Analog Layout Synthesis

The embodiments of the invention include methods, apparatus, and systems for Interactive Analog Layout Synthesis of Integrated Circuits.

Using an analog layout synthesis tool, a user may find solutions that meets the constraints and objectives of the design but still is not the preferred solution. Often a user would like to improve upon a prior solution due to individual preferences. These individual preferences may be difficult for a user to mathematically describe as the constraints and objectives of the design. For example, a circuit designer often has individual preferences on how the layout should look but does not know how to describe it mathematically. Therefore, it is desirable to have means so that a user can interactively and iteratively improve upon a prior solution further without having to start the synthesis process from the very beginning or manually update the constraints and objectives of a design.

A method of analog layout synthesis is disclosed herein where a series of new analog layout synthesis jobs or runs are executed using the solutions and/or sub-solutions from one or more previous synthesis runs as the initial starting point. By repeating the analog layout synthesis several times, the layout solutions will be improved and converge to a set of solutions that a user prefers.

### Introduction to Hierarchical Analog Layout Synthesis

A hierarchical analog layout synthesis (HALS) tool can generate a semiconductor layout of an integrated circuit design that includes analog circuitry. It is capable of reading SPICE (“Simulation Program with Integrated Circuit Emphasis”) netlists and generating hierarchical layouts of analog circuitry. The hierarchical analog layout synthesis tool performs the functions of partitioning, placement, and routing. The hierarchical analog layout synthesis tool coincidentally places and routes the analog circuitry.

During partitioning, transistors that are to be connected to each other may be grouped together and form an initial placement which is then routed with any adjustment in placement to complete the routing. Then, the placement and routing is optimized iteratively over a number of goals and objectives to generate multiple layouts for presentation to a user.

A user may give one or more directives to the HALS tool in order to specify certain constraints in the layout such as grouping certain devices together, spacing certain devices apart, or placing certain devices at specific locations of the layout.

The HALS tool provides global hierarchical layout optimization by generating multiple layouts for each layout hierarchy level. Given a set of layout optimizing criteria for the entire circuit, the HALS tool further provides a means of searching and retrieving from the all levels of layout hierarchy, the one or more layout solutions satisfying the given layout criteria. The HALS tool accomplishes this by applying the concepts of multi-objective optimization and Pareto fronts to provide a hierarchical global analog circuit layout optimization. A hierarchical global analog circuit layout optimization is achieved by optimizing the entire layout at all levels of layout hierarchy, including any upper level of layout hierarchy and all lower levels of layout hierarchy.

A Pareto front and a “shape curve” (see the shape curve illustrated in FIG. 12) share similar features. A “shape curve” is a limited and degenerated case of a pareto front that has two objectives. That is, a shape curve is a plot of layout solutions for a cell, a subcircuit, or other level of circuit hierarchy with two objectives on X and Y axes. For example, one shape curve is a plot of a plurality of layout solutions with the criteria of circuit heights and circuit widths, such as illustrated in FIG. 12.

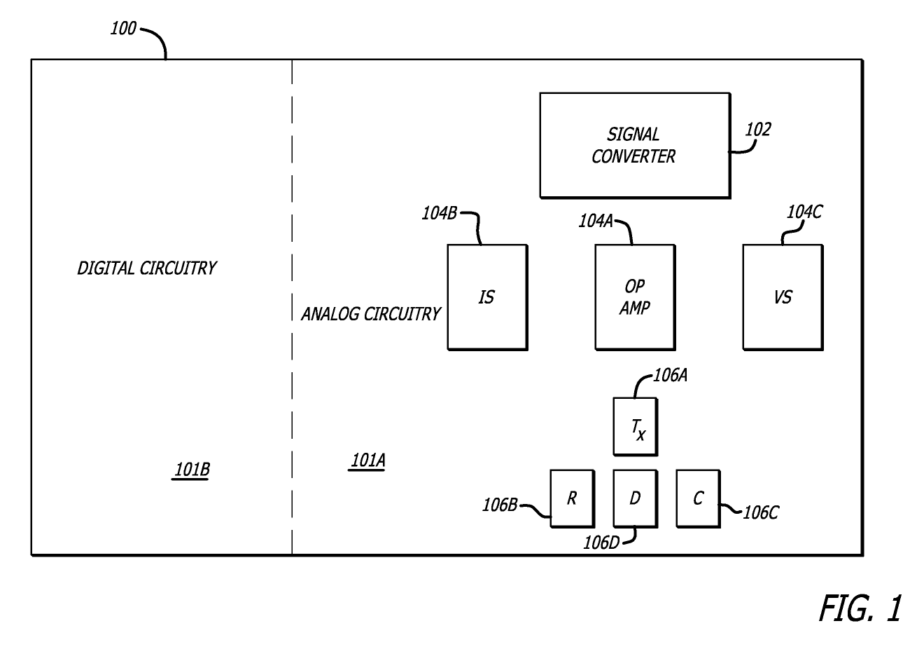

Referring now to FIG. 1, an integrated circuit design 100 is illustrated upon which embodiments of the invention may operate. The integrated circuit design includes an analog circuit portion 101A and a digital circuit portion 101B.

The hierarchical analog layout synthesis tool (HALS tool) may handle different levels of circuit hierarchy in an analog integrated circuit design. The levels of hierarchy in an analog integrated circuit design may include a top chip level, a mega block level, a macro block level, and a micro block level. An example of a mega-block is a signal converter 102, such as an analog to digital converter (ADC) or a digital to analog converter (DAC). Examples of macro-blocks include an operation amplifier (OPAMP) 104A, a current source (IS) 104B, and a voltage source (VS) 104C. Examples of micro-blocks include discrete semiconductor devices such as transistors 106A, resistors 106B, capacitors 106C, and diodes 106D.

As discussed previously, the hierarchical analog layout synthesis tool may handle different levels of hierarchy in an analog integrated circuit design. The hierarchy of an analog layout integrated circuit design may be further abstracted into a plurality of levels.

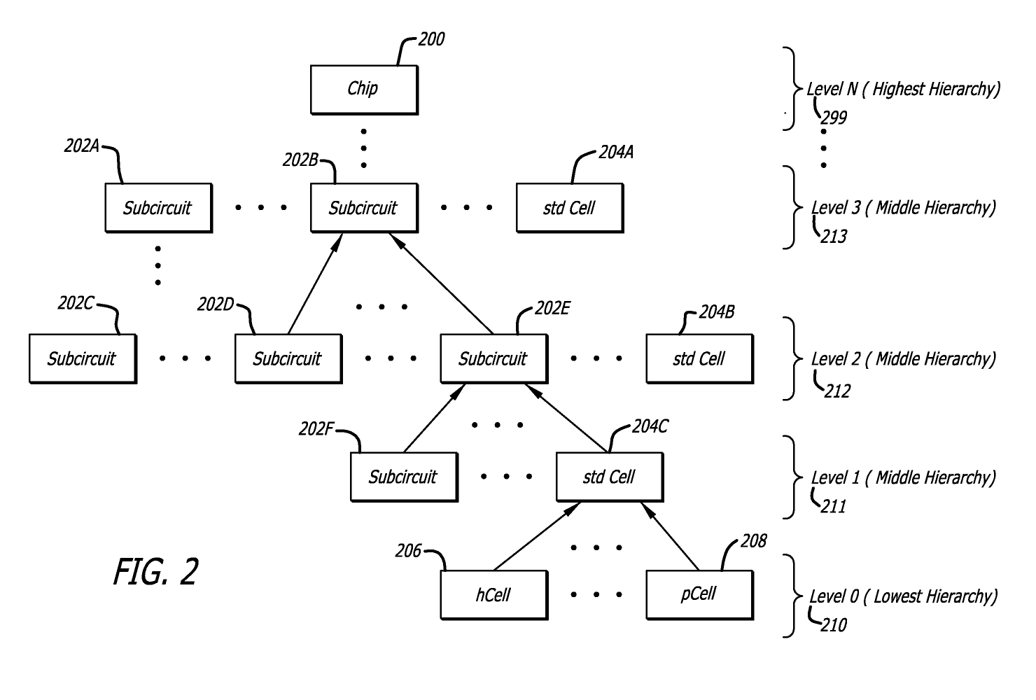

Referring now to FIG. 2, a plurality of circuit hierarchy levels may be defined from a level 0 (a lowest level of hierarchy) 210 through to a level N (a highest level of hierarchy) 299 for an integrated circuit chip hierarchy.

At level N 299 of the layout hierarchy, the top or chip level 200 is a subcircuit at the highest level of layout hierarchy. The top or chip level 200 may be formed out of one or more levels of layout hierarchy as illustrated

At middle levels of layout hierarchy, level 1 211 through level N−1 (not shown), one or more standard cells (stdcell) 204A-204C and/or one or more subcircuits 202A-202F may be found. A standard cell includes a pCell and/or an hCell which are defined below.

At the lowest level of layout hierarchy, level 0 210, one or more pCells and/or one or more hCells may be instantiated in the integrated circuit design. As previously discussed, pCell and/or an hCell may be included in a standard cell 204A-204C.

The pCells are circuit cells that are parameterizable cells having flexible cell heights and cell widths. Examples of pCells are transistor, resistor, and capacitor. The hCells are circuit cells that are hard cells having a fixed cell height and a fixed cell width. Examples of hCells are pre-laid circuit objects such as a memory block or memory cell.

### Hierarchical Analog Layout Synthesis Tool and System

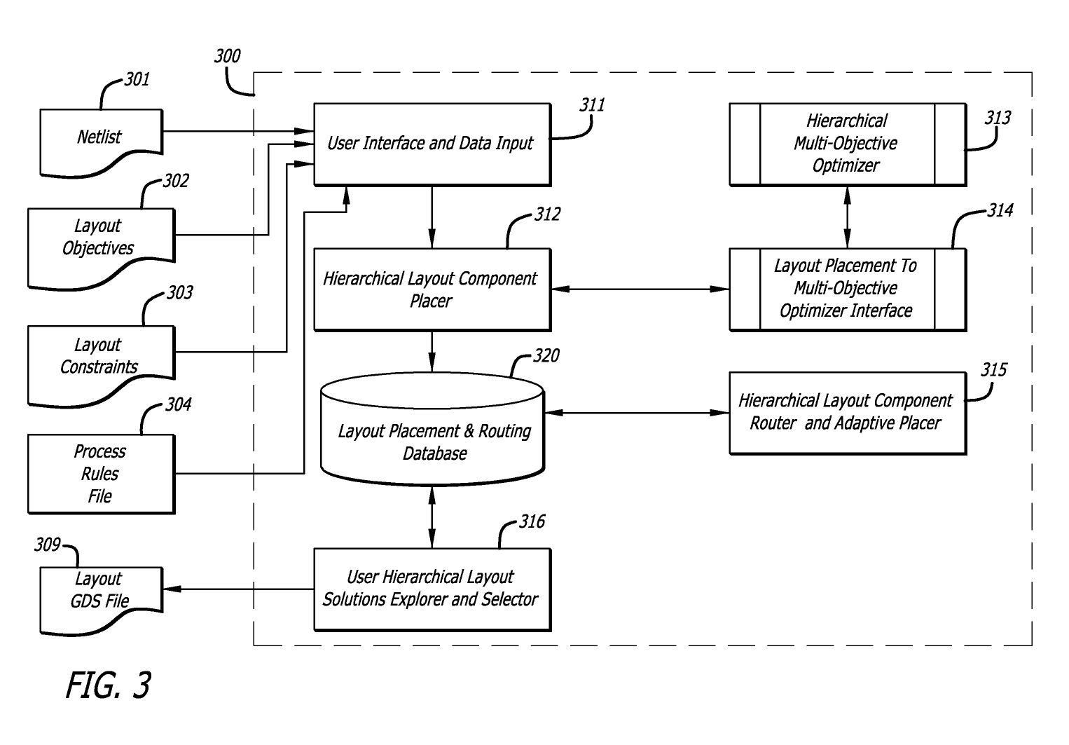

Referring now to FIG. 3, a functional block diagram of a hierarchical analog layout synthesis tool (“HALS tool”) 300 and system are illustrated.

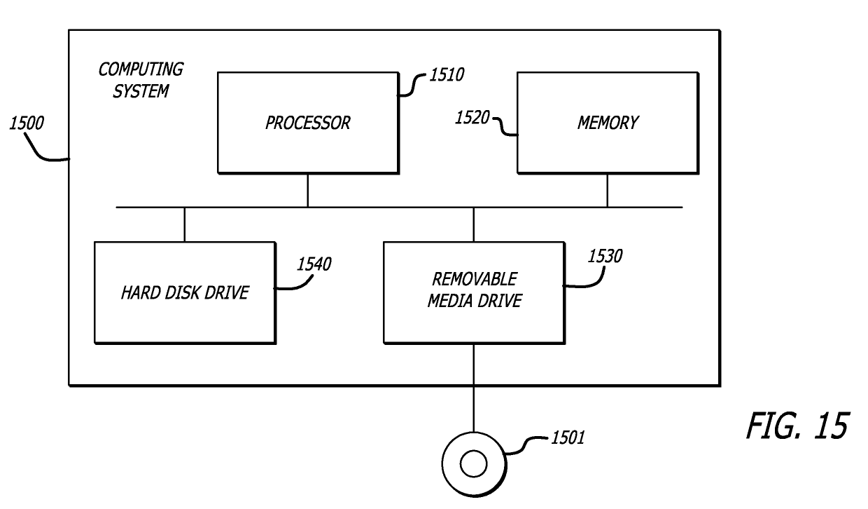

The HALS tool 300 is application software that is executable with an operating system (OS) on a computer system, such as that illustrated in FIG. 15. The HALS tool 300 receives a circuit netlist 301, layout objectives 302, layout constraints 303, and a process rules file 304. The layout objectives 302, layout constraints 303 and process rules file 304 and process rules file 304 may be collectively referred to as the layout synthesis directives and specifications.

The circuit netlist 301 is typically a spice transistor level netlist that includes a reference to the appropriate process specification that was utilized in its generation.

The layout objectives 302 and layout constraints 303 may be user specified which are to be taken into account in generating a plurality of layout solutions. The layout objectives are goals to be minimized or maximized. The layout constraints are conditions that must be met in order to generate a layout solution. The layout constraints 303 may be categorized as being physical layout constraints and/or electrical layout constraints. An exemplary physical layout constraint is a binning directive described further below. Exemplary electrical layout constraints are matching, routing capacitance, ground drops, current density, and antenna effects.

The process rules file 304 is a file containing the layout design rules for the targeted process of a wafer fabrication facility in which the semiconductor integrated circuit is to be manufactured, such as minimum width and minimum spacing of polygons on each layer.

The HALS tool 300 generates a selected optimized layout file 309 from a plurality of layout solutions to be output there-from. The layout file 309 may be in a GDSII file format, for example, including a plurality of mask layers to manufacture the semiconductor integrated circuit in a monolithic substrate.

The HALS tool 300 includes a user interface and data input reader 311, a hierarchical layout component placer 312, a hierarchical multi-objective optimizer 313, a hierarchical layout component router and adaptive placer 315, and a hierarchical layout solutions explorer and selector user interface 316 coupled together as shown. A layout placement to multi-objective optimizer software interface 314 may couple the hierarchical layout component placer 312 and the hierarchical multi-objective optimizer 313 together. The HALS tool 300 further includes an integrated analog layout placement and routing database 320 which is generated by the hierarchical layout component placer 312 and the hierarchical layout component router 315.

The hierarchical layout solutions explorer and selector user interface 316 reads the analog layout solutions that are in the database 320 and provides a user interface from which the one or more layout solutions may be analyzed and selected.

The user interface and data input reader 311 reads the user circuit data required for layout synthesis including the circuit netlist 301 and the layout synthesis directives (layout objectives 302, layout constraints 303) and specifications. The user interface and data input reader 311 may also read in layouts of the lowest level of layout hierarchy, such as the pCells and the hCells, or a prior subcircuit layout.

The hierarchical layout solutions explorer and selector user interface 316 and the user interface and data input reader 311 may be integrated into a single user interface by combining the functionality of each.

The integrated layout placement and routing database 320 is an internal database for data processing and input/output. The integrated layout placement and routing database 320 stores the plurality of layout solutions that are made available to the user through the hierarchical layout solutions explorer and selector user interface 316.

The hierarchical layout component placer 312 performs the initial placement of components (e.g., Transistors, diodes, resistors, capacitors, inductors, pCells, hCells, StdCells, subcircuits, etc.) in the layout at each level of hierarchy of the integrated circuit chip.

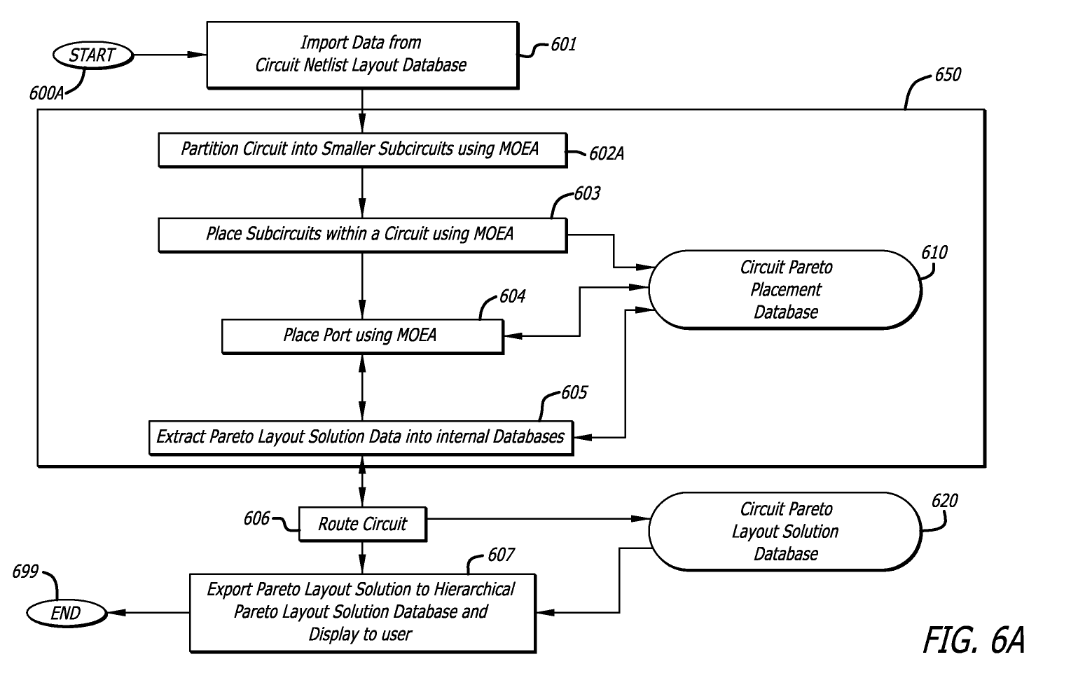

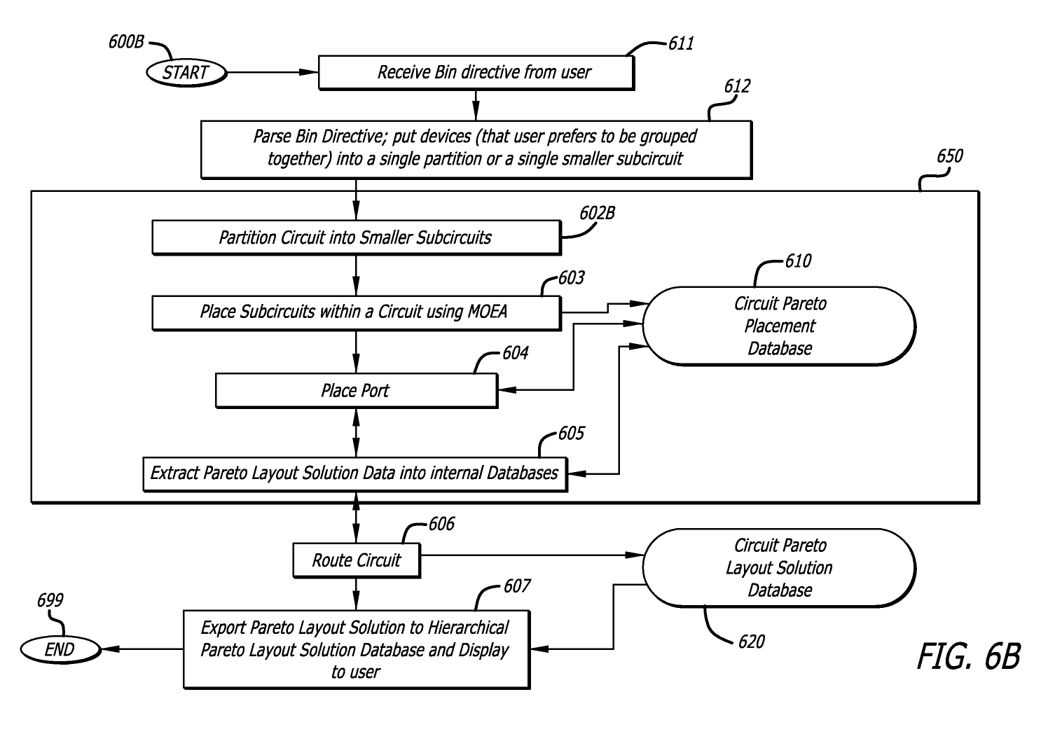

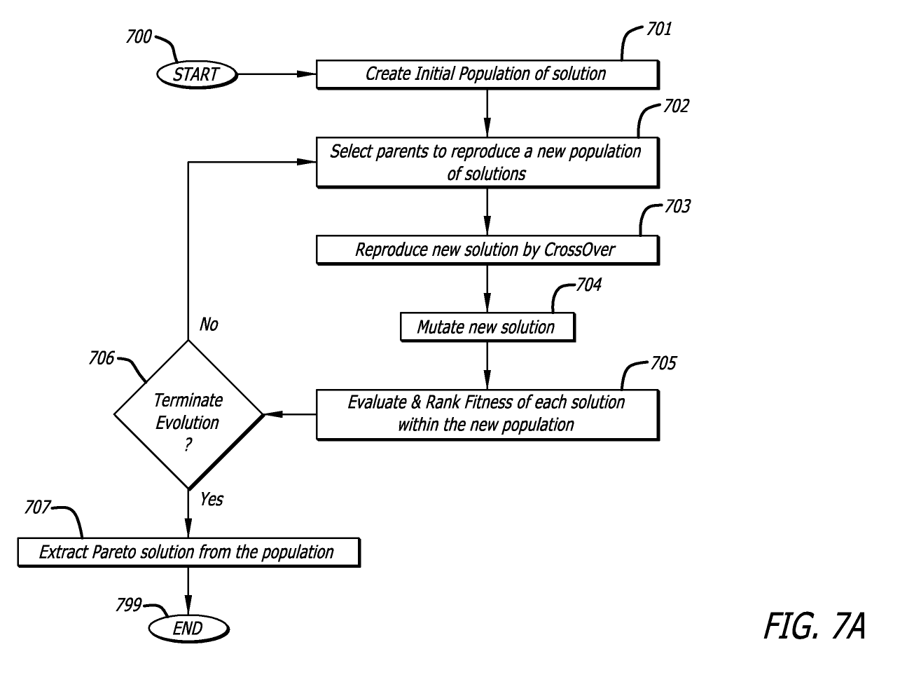

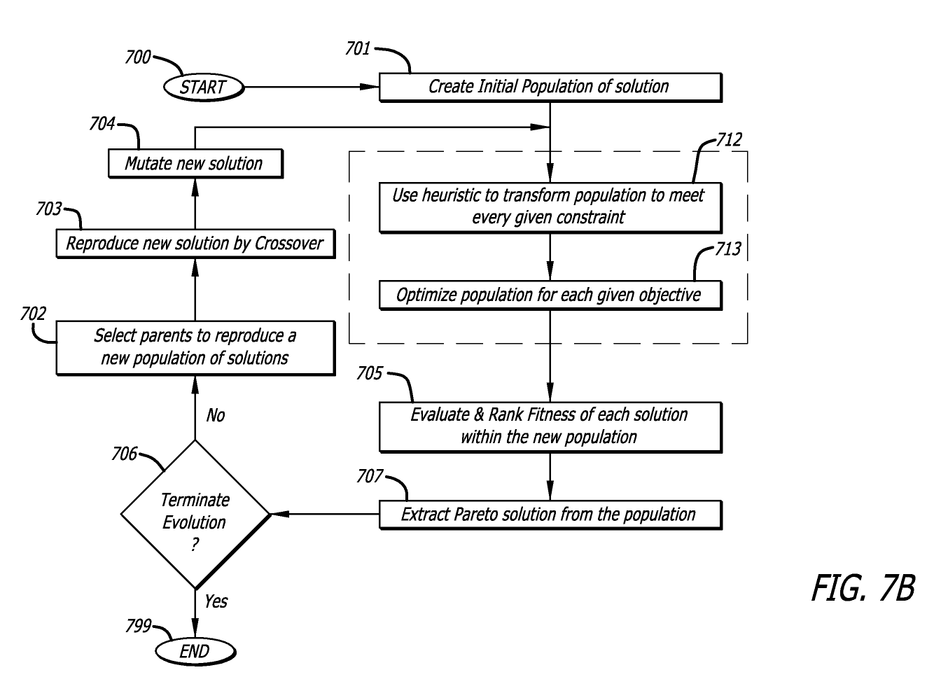

The hierarchical multi-objective optimizer 313 optimizes the placement of components (e.g., Transistors, diodes, resistors, capacitors, inductors, pCells, hCells, StdCells, subcircuits, etc.) using a variety of multi-objective optimization algorithms. One such algorithm is MOEA and is described further below with reference to FIGS. 6A and 7A. A general multi-objective optimization algorithm is described further below with reference to FIG. 7B.

The layout component placer to Multi-Objective Optimizer Interface 314 is a software module that interfaces between the hierarchical layout component placer 312 and the hierarchical multi-objective optimizer 313.

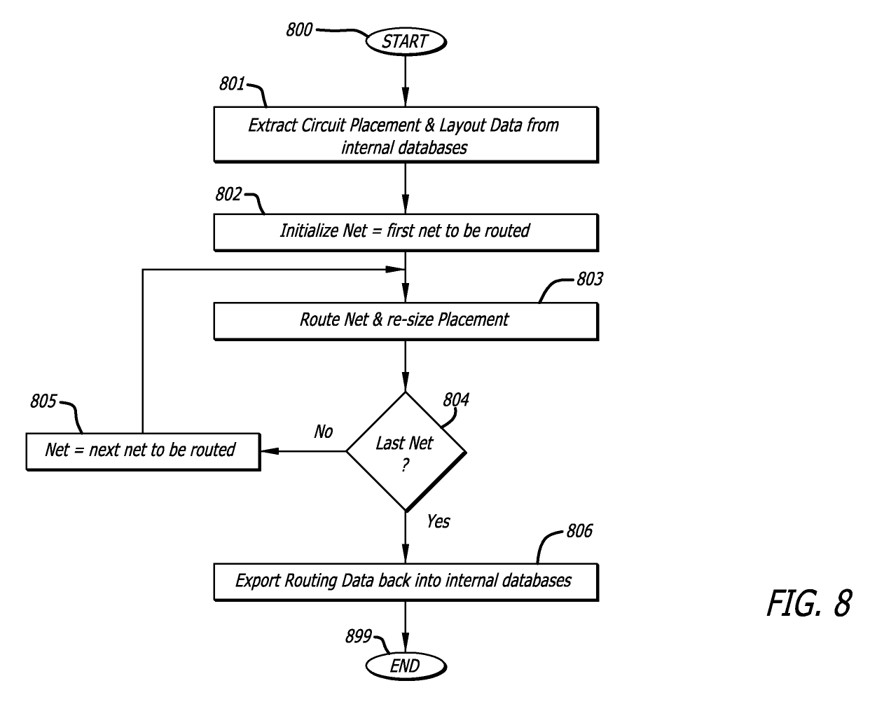

The hierarchical layout component router 315 coincidentally routes nets or the wire interconnect between levels and ports of the cells and subcircuits that were placed by the hierarchical layout component placer 312. A routing of a net or wire interconnect will almost always be made as the placement of the components will be adjusted to accommodate the routing. The hierarchical layout component router 315 is described further below with the description of FIG. 8.

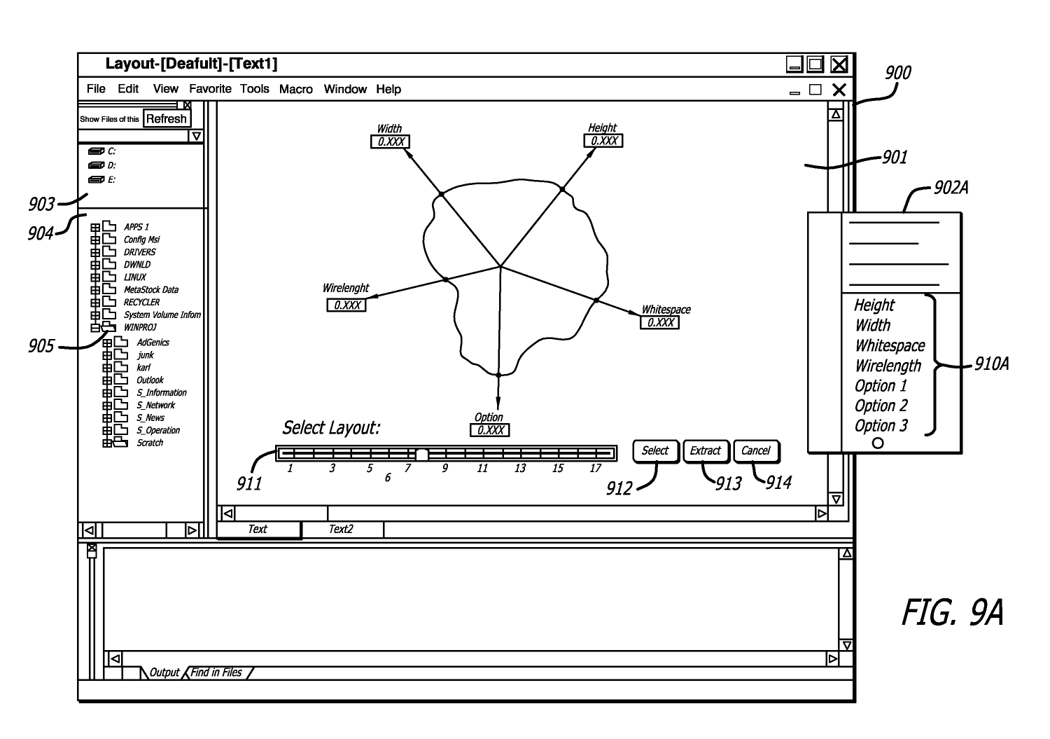

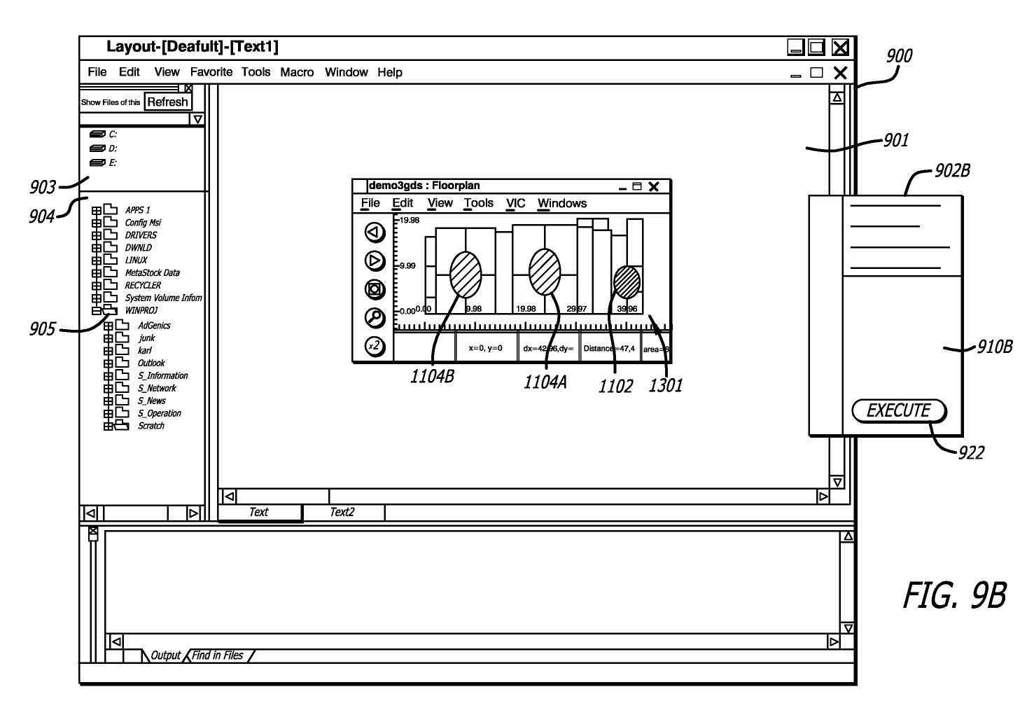

The hierarchical layout solutions explorer and selector user interface 316 allows a user to browse through the plurality of layout solutions that are generated and make a selection based on certain criteria. The hierarchical layout solutions explorer and selector user interface 316 is described more fully below with the description of FIGS. 9,10A-10B.

### Analog Circuit Synthesis Flow

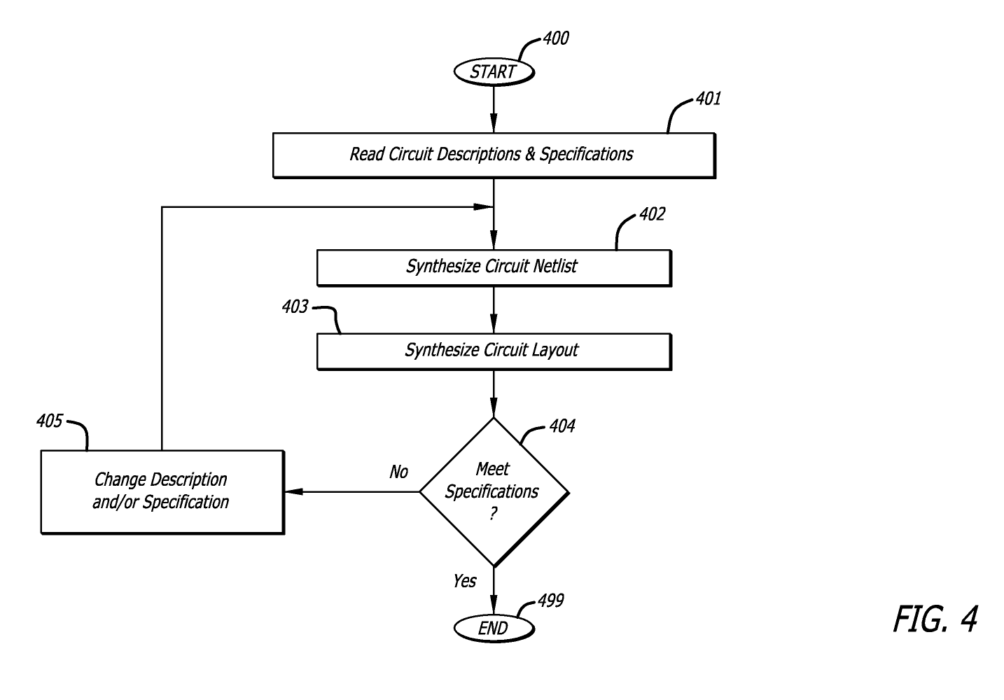

Referring now to FIG. 4, a flow chart diagram of analog circuit synthesis design flow is illustrated, including the synthesis of the analog circuit layout by the system and tool of FIG. 3.

At block 401, the circuit descriptions and specification are determined and read. The process then goes to block 402.

At block 402, a circuit netlist is synthesized such as through the use of a spice circuit program. The process then goes to block 403.

At block 403, the HALS tool 300 synthesizes the analog circuit layout given the circuit netlist previously formed in the synthesis of the circuit netlist (block 401), and the circuit descriptions and specification read in block 401.

At block 404, a determination is made as to whether or not the specifications for the analog circuit were met. If so, the process goes to block 499 and ends. If the specifications for the analog circuit were not met, the process goes to block 405.

At block 405, the circuit description and/or circuit specifications are changed if the layout does not meet the initial specifications. If the circuit specification and/or description are changed, then the process goes back to block 402 and the circuit netlist and layout are re-synthesized.

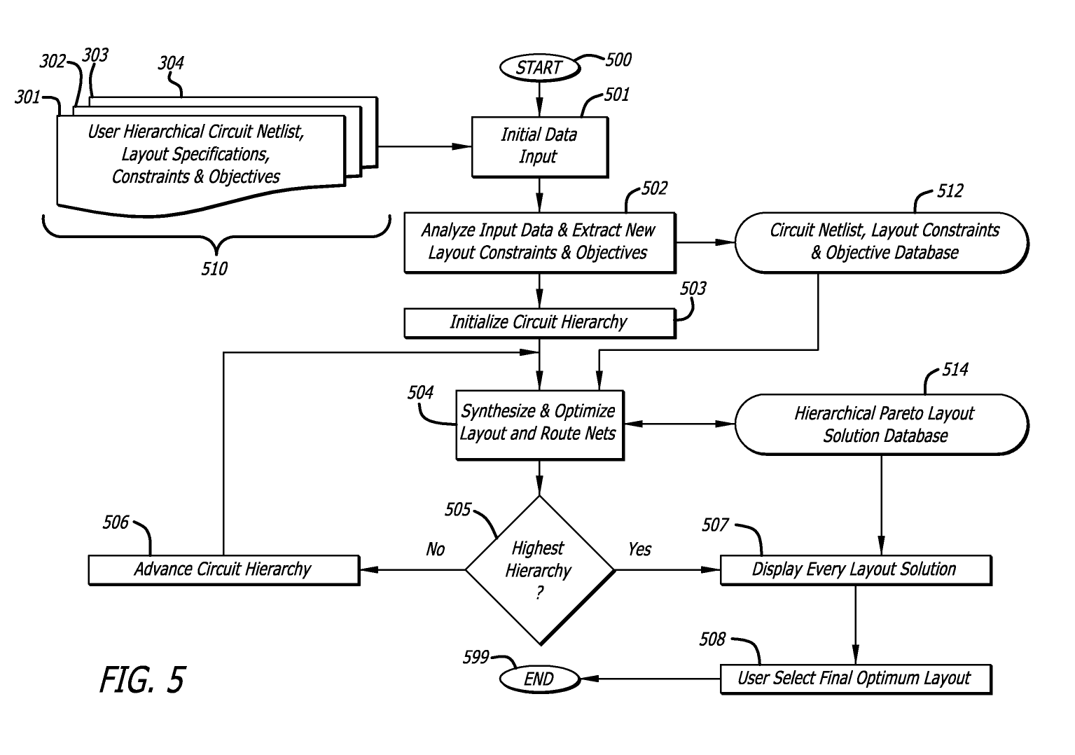

Referring now to FIG. 5, a system flow chart diagram of the hierarchical analog layout synthesis and optimization performed by the system and tool of FIG. 3 is illustrated.

The layout synthesis and optimization starts at block 500 and then goes to block 501.

At block 501, initial data input 510 is coupled into the IC design software (HALS tool 300), such as the User Hierarchical Circuit Netlist 301, the user Layout Specifications 303, initial user constraint and objectives 302, and process rules file 304. The user interface 311 in the HALS tool 300 receives the initial data input 510. The process then goes to block 502.

At block 502, the initial data input is analyzed and new/additional layout constraints and objectives are extracted. This is performed by the user interface 311 of the HALS tool 300. The user's circuit netlist and new/additional layout constraints and objectives are stored into the database 512 that will be later used to synthesize and optimize the layout.

At block 503, the circuit hierarchy is initialized. The initial circuit hierarchy is extracted from the user's circuit netlist.

At block 504, given the initial circuit hierarchy and the Circuit Netlist, Layout Constraints and Objective Database 512; the analog layout is synthesized and optimized at block 504. During this process, the initial circuit hierarchy is mapped into appropriate levels of hierarchy in accordance with the exemplary hierarchy of FIG. 2, described previously. The analog layout is synthesized, optimized, and the wire nets routed at block 504 by the hierarchical layout component placer 312, the hierarchical multi-objective optimizer 313, and the hierarchical layout component router and adaptive placer 312 illustrated in FIG. 3. This process generates a hierarchical Pareto layout solutions database 514 that includes a plurality of layout solutions for the analog integrated circuit.

The database 514 storing the layout solutions and the database 512 storing the user's circuit netlist and new/additional layout constraints and objectives may be part of the unified layout placement and routing database 320.

Next at block 505, a determination is made if the layout that was just synthesized and optimized at block 504 was at the highest level of hierarchy in the integrated chip hierarchy. If the highest level of integrated chip hierarchy was synthesized and optimized at block 504, the process goes to block 507. If the highest level of integrated chip hierarchy was not synthesized and optimized at block 504, the process goes to block 506.

At block 506, the level of circuit hierarchy is advanced to the next higher level of integrated circuit chip hierarchy. The process then goes to block 504 and synthesizes and optimizes the layout at the next higher level of circuit hierarchy. The process continues in the loop of blocks 504-506 until the highest level of hierarch is reached and the process goes to block 507.

At block 507, assuming that the highest level of layout hierarchy of the desired circuit was synthesized and optimized, every layout solution that is generated by the HALS tool 300 is displayed to the user by means of the layout solutions user interface 316.

Then at block 508, the user may select the final optimum layout by means of the layout solutions user interface 316. The process then goes to block 599 and ends.

### Circuit Partitioning and Placement Using MOOA/MOEA Methods

Referring now to FIG. 6A, a synthesis and optimization layout flowchart is illustrated. The synthesis and optimization of the layout begins at block 600A and then goes to block 601.

At block 601, data from the Circuit Netlist Layout Database 512 is imported to begin synthesizing and optimizing the layout. Blocks 602A-606 perform a hierarchical placement 650 of elements to form an analog circuit layout.

At block 602A, the circuit is partitioned into smaller sub-circuits using a multi-objective optimization algorithm (MOOA) or a multi-objective evolutionary algorithm (MOEA). The MOOA is generally described below with reference to FIG. 7B while the MOEA is generally described below with reference to FIG. 7A.

At block 603, sub-circuits are placed within a circuit using the MOOA or MOEA criteria. This forms part of the Circuit Pareto Placement Database 610.

At block 604, the ports of the circuit and sub-circuits are placed using the MOOA or MOEA. The port placement also forms part of the Circuit Pareto Placement Database 610.

At block 605, Pareto Layout Solution Data is extracted into internal databases, such as the Circuit Pareto Placement Database 610. This allows other software components of the HALS tool 300 to gain access.

At block 606, the circuit is routed to generate the Circuit Pareto Layout Solution Database 620. During routing by the hierarchical layout component router 315, the hierarchical layout component router 315 may be invoked to change the placement of the subcircuits within a circuit as well as the placement of the ports. That is, if the initial routing was not successful, the process may go back and repeat blocks 603-605 and update the circuit pareto placement database 610. Otherwise if the initial routing was successful, the layout is generated and added to the Circuit Pareto Layout Solution Database 620.

Next at block 607, the Pareto Layout Solutions are exported to the Hierarchical Pareto Layout Solution Database 514 and the layout solution is displayed to a user. The process then goes to block 699 and ends.

The Circuit Pareto Placement Database 610 and the Circuit Pareto Layout Solutions Database 620 may also be part of the unified layout placement and routing database 320.

In the automatic laying out of analog circuitry, circuit partitioning, device/subcircuit placement, and port placement may all be considered to be either multi-objective optimization algorithm (MOOA) problems or multi-objective evolutionary algorithm (MOEA) problems that have a Pareto solution. The following discussion introduces the constraints and objectives forming the multiple objectives, the measures of fitness of the solutions, and the representation of the Pareto solution to each of these problems.

### A) Circuit Partitioning as an MOOA/MOEA Problem

In the process 602 of circuit partitioning a circuit netlist into smaller subcircuits, the Pareto solution representation is a sets of devices that are to be laid-out together at a level of the integrated circuit chip hierarchy.

The measure of fitness (or objectives) of the circuit portioning can be any mathematical relationship among different layout metrics and typically are (i) the cost of having devices separated into different sets and (ii) the cost of having multiple sets of devices.

The constraints of the circuit portioning can be any mathematical relationship among different layout metrics and typically are (i) the maximum number of sets and (ii) the minimum number and the maximum number of devices per set.

### B) Device/Subcircuit Placement as an MOOA/MOEA Problem

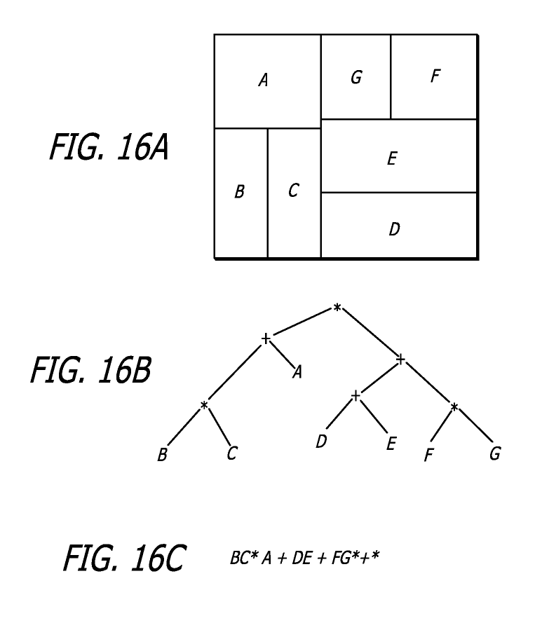

In the process 603 of device/subcircuit placement into a circuit layout, the placement representations are floorplans described as polish expressions (see FIGS. 16A, 16C); devices or subcircuits (of different layout aspect ratio) as operands; device or subcircuit placements as the operators at a level of the integrated circuit chip hierarchy.

Referring momentarily to FIGS. 16A-16C, FIG. 16A illustrates a layout floorplan for an integrated circuit. The layout floorplan includes floorplan slices A-G. The floorplan slices A-G may also be referred to as blocks.

FIG. 16B illustrates a slicing tree representation for the layout floorplan of FIG. 16A. The floorplan slices A-G are combined together by the operators * and + into the top chip level.

FIG. 16C illustrates a polish expression representation of the layout floorplan of FIG. 16A. The polish expression representation of the layout floorplan illustrated in FIG. 16C also corresponds to the slicing tree representation of the layout floorplan of FIG. 16B. The floorplan slices A-G are the operands in the polish expression representation of the layout floorplan. The operators * and + combining the floorplan slices A-G together are the operators in the polish expression representation of the layout floorplan.

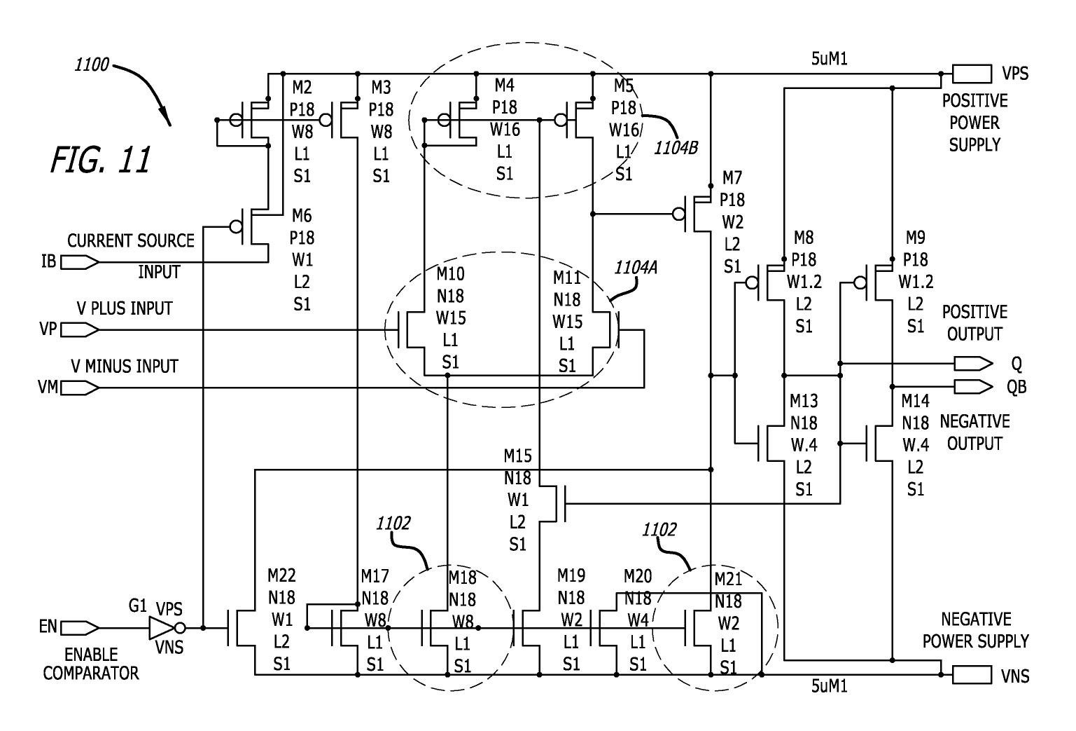

Referring momentarily to FIG. 12, a shape curve for the subcircuit of the comparator illustrated in FIG. 11 having different layout aspect ratios of subcircuit height and subcircuit width.

The measures of fitness (or objectives) of the of Device/Subcircuit Placement into a circuit layout can be any mathematical relationship among different layout metrics and typically are (i) the cost of unused space between placed device or subcircuit; (ii) the height and the width of the floorplan; and (iii) the wire length and the wire jogging between connecting devices or subcircuits.

The constraints of Device/Subcircuit Placement into a circuit layout can be any mathematical relationship among different layout metrics and typically are (i) relative device-to-device (device-to-subcircuit or subcircuit-to-subcircuit) placement criteria, and (ii) relative device-to-floorplan (subcircuit-to-floorplan) placement criteria.

C) Port Placement as an MOOA/MOEA problem

In the process 604 of port placement for the devices/subcircuits in the circuit layout, the port placement representations are an integer string of subcircuits or devices; an integer value represent a flipping operator at a level of the integrated circuit chip hierarchy. The flipping operator controls the orientation of the subcircuit or devices; and hence controls the port location of the subcircuit or device.

The measure of fitness (or objectives) of the Device/Subcircuit Placement into a circuit layout is typically the wire length between connecting subcircuits or devices.

There typically are no constraints on the port placement for the devices/subcircuits in the circuit layout.

Referring now to FIG. 7A, a Multi-Objective Evolutionary Algorithm flow chart, an implementation of a general Multi-Objective Optimization Algorithm, is illustrated that may be followed by the hierarchical layout component placer 312 and the hierarchical multi-objective optimizer 313 to perform the processes 602-604. The MOEA algorithm begins at block 700 and then jumps to block 701.

At block 701 an initial population of the layout solutions is created by randomly selecting the operators and operands for the polish expression of the layout. The process then goes to block 702.

At block 702, parent layout solutions are selected to reproduce a new population of layout solutions. The selection of the parent layout solution is performed by picking the layout solutions with the best fitness and best constraint measure (as described in the process 603). The process then goes to block 703.

At block 703, a new layout solution is reproduced by crossover of two layout solutions. The crossover is done by combining and mixing portions of the polish expressions of two parent layout solutions into a polish expression of a new layout solution. The process then goes to block 704.

At block 704, the new layout solution that was reproduced by the process of block 703 is mutated into a differing new solution and included in the new population of layout solutions. The mutation is performed by randomly changing the operands and/or operators in the polish expression of the layout solution. For example, in FIGS. 16A-16C, discussed previously, the operands are the layout blocks labeled A through G. The operators are the single character symbols (*+). The operators control how operands are placed relative to each other. For example, consider the polish expression (B C*A+). The portion B C* of the polish expression means that block B is placed left of block C. Continuing along the polish expression, the portion A+ there-after indicates that block A is placed on top of block B and block C. The process then goes to block 705.

At block 705, the fitness of each layout solution within the new population of layout solutions is evaluated and ranked. The layout solution is evaluated per the fitness and constraints (described in process 603). Ranking is done by sorting the layout solutions per their fitness value. The process then goes to block 706.

Then at block 706, a determination is made whether to terminate the evolution of new layout solutions or to continue generating new layout solutions. If the evolution of new layout solutions is not terminated, the process goes to block 702 and repeats the process of blocks 702-705. If the evolution of new layout solutions is to be terminated, the process goes to block 707. The evolution of new layout solutions is terminated when one of the following conditions is met: i) CPU time has exceeded a pre-set limit or ii) a new layout solution that is better than the others is not found within a given period of time.

At block 707, the pareto solution, a “shape curve”, is extracted from the population of layout solutions. As discussed previously, FIG. 12 illustrates a shape curve. The process then goes to block 799 and ends.

As the MOEA method of FIG. 7A may be slow in processing, the method may be rearranged with added elements into a more general multi-objective optimization algorithm in order to speed up processing of the MOEA and improve the probabilities of finding the most optimal pareto solution set, such as illustrated in FIG. 7B.

Referring now to FIG. 7B, a Multi-Objective Optimization Algorithm flow chart is illustrated that may be followed by the hierarchical layout component placer 312 and the hierarchical multi-objective optimizer 313 to perform the processes 602-604. The MOOA algorithm begins at block 700 and then jumps to block 701.

At block 701 an initial population of the layout solutions is created by randomly selecting the operators and operands for the polish expression of the layout. The process then goes to block 712.

At block 712, heuristic algorithms are used to transform the present population of layout solutions to meet each and every given layout constraint. Two fundamental goals in computer science are finding algorithms with provably good run times and with provably good or optimal solution quality. A heuristic is an algorithm that either provides good run times to the problem, or good or optimal solution quality to the problem, or both. For example, a heuristic algorithm may usually find pretty good solutions to the problem but there is no proof the solutions could not get arbitrarily bad; or the heuristic algorithm may usually run reasonably quickly to find a solution, but there is no argument that this will always be the case. A heuristic algorithm is used because transforming a population of layout solutions to meet each and every given layout constraint is so difficult of a problem that there is no known non-heuristic algorithm for solving it.

If this is the first pass through the process, the present population is the initial population of layout solutions. The process then goes to block 713.

At block 713, the transformed population of layout solutions is then optimized to meet each and every given layout objective. The added process elements of block 712 and 713 speed up processing of the MOEA and improve the probabilities of finding the most optimal pareto solution set. The process then goes to block 705.

At block 705, the fitness of each layout solution within the new population of layout solutions is evaluated and ranked. The layout solution is evaluated per the fitness and constraints (described in process 603). Ranking is done by sorting the layout solutions per their fitness value. The process then goes to block 707.

At block 707, the pareto solution, a “shape curve”, is extracted from the population of layout solutions. As discussed previously, FIG. 12 illustrates a shape curve. The process then goes to block 706.

At block 706, a determination is made whether to terminate the evolution of new layout solutions or to continue generating new layout solutions. If the evolution of new layout solutions is not terminated, the process goes to block 702 and repeats the process of blocks 702, 703, 704, 712, 713, 705, and 707. If the evolution of new layout solutions is to be terminated, the process goes to block 799 and ends. The evolution of new layout solutions is terminated when one of the following conditions is met: i) CPU time has exceeded a pre-set limit or ii) a new layout solution that is better than the others is not found within a given period of time.

Assuming the process is not terminated and it is to continue generating new layout solutions, the process goes to block 702.

At block 702, parent layout solutions are selected to reproduce a new population of layout solutions. The selection of the parent layout solution is performed by picking the layout solutions with the best fitness and best constraint measure (as described in the process 603). The process then goes to block 703.

At block 703, a new layout solution is reproduced by crossover of two layout solutions. The crossover is done by combining and mixing portions of the polish expressions of two parent layout solutions into a polish expression of a new layout solution. The process then goes to block 704.

At block 704, the new layout solution that was reproduced by the process of block 703 is mutated into a differing new solution and included in the new population of layout solutions. The mutation is performed by randomly changing the operands and/or operators in the polish expression of the layout solution. For example, in FIGS. 16A-16C, discussed previously, the operands are the layout blocks labeled A through G. The operators are the single character symbols (*+). The operators control how operands are placed relative to each other. For example, consider the polish expression (B C*A+). The portion B C* of the polish expression means that block B is placed left of block C. Continuing along the polish expression, the portion A+ there-after indicates that block A is placed on top of block B and block C. The process then goes back to repeat the process of block 712 and the process that follows thereafter.

### Wire/Net Routing

Referring now to FIG. 8, a detailed flow chart of the circuit routing process 606 is illustrated. The process of circuit routing begins at block 800 and then goes to block 801.

At block 801, the Circuit Placement and Layout Data is extracted from the internal databases 320, 512, 610. The process then goes to block 802.

At block 802, a variable Net is initialized to be the first net that is to be routed. The process then goes to block 803.

At block 803, the given Net is routed and the placement of a device/subcircuit may be re-sized or moved concurrently with the routing. The process then goes to block 804.

At block 804, a determination is made if it is the Net just routed was the last net to be routed. If the last net was routed, the process goes to block 806. If the last net was not routed, the process goes to block 805.

At block 805, the variable Net is updated to be the next net that is to be routed. The process then goes to block 803 where the Net is routed and any re-size and re-placement concurrently occurs to complete the route.

At block 806, assuming the last net has been routed by the HALS tool 300, the routing data is exported into the internal databases 320, 512, 610. The process then goes to block 899 and the routing process ends.

### Layout Selection

With the HALS tool generating multiple layout solutions, it is a challenge to communicate to a user information regarding the multiple analog circuit layout solutions. The HALS tool includes a layout selection user interface to communicate to a user information regarding the multiple analog circuit layout solutions. The layout selection user interface integrates and simplifies a user interaction with the HALS tool. The layout selection user interface offers flexibility in choosing only data of interest to a user, a view of layout implementation trade-offs, a view of layout sensitivity information, a method to compare data against each of the multiple analogy layout solutions, and detailed information for the selected layout that meets designers objectives and enables design verification—layout graphical data plots (e.g., GDSII), parasitics, layout data, etc.

As mentioned previously, a hierarchical layout solutions explorer and selector user interface allows a user to browse through the plurality of layout solutions that are generated and make a selection based on certain criteria.

Referring now to FIG. 9A, a layout selection user interface 900 of the HALS tool is displayed on a monitor of a computer system for the layout selection process by a user. The layout selection user interface 900 may also be referred to herein as a “layout selection cockpit” or a “hierarchical layout solutions explorer and selector user interface”.

The layout selection user interface 900 includes a plot window 901, a menu 902, a navigation window 903 including a list of drives and folders 904. The navigation window 903 merges the directory structure, design hierarchy, and the information generated by the HALS tool 300. The organization of the navigation window 903 is more a logical organization than a physical organization so that the GDSII layout, the circuit partition, circuit netlist sections, the shape curves, logs, files, etcetera are grouped together. For example, a user may navigate to any desired level of integrated chip hierarchy from the navigation window. A design file 905 may be selected in the navigation window 903 to present layout information to a user. A user may select that a layout analysis be performed on the design file.

The menu 902 may be a pop-up menu that is selected by a mouse click, for example. The menu 902 includes a list of layout constraints that were applied to the analog circuitry for the selected level of integrated chip hierarchy. Additionally, from the menu, the user can select the type of plot window to show and select the graphs or axes to display. Furthermore, the menu 902 can allow the user to select and view the circuit netlist file, an individual gds file, and/or other information related to the selected level of design hierarchy.

The plot window 901 can display a plurality of plot types. In one embodiment of the invention, the plot window 901 displays a multiple dimension plot. In another embodiment of the invention, the plot window 901 displays one or more two dimensional (2-D) plots. In this manner, the embodiments of the invention provide a flexible method to compare and view data across a plurality of analog layout solutions.

The plot window 901 includes a sliding switch 911 to offer to display many layout solutions to a user through sliding the switch 911. That is, the sliding switch 911 is used to select the desired analog layout solution to display from the many analog layout solutions.

The plot window 901 may further include a select button 912, an extract button 913, and a cancel button 914. A user mouse clicks on the select button 912, the extract button 913, and/or the cancel button 914 to select it.

The select button 912 is used to select the analog layout solution that is desired by a user to be displayed in a layout display window. In this manner, the HALS tool offers a user an integrated environment to view and select his favorite layout solution among multiple layout solutions synthesized by the HALS tool. The cancel button 914 cancels the user selection of the analog layout solution. The extract button 913 is provided to generate and export a computer-readable file or database to a user designated area of the selected design. The exported file or database may be used with other IC design software tools to perform further analysis or to integrate the analog circuitry with other circuitry, such as digital circuitry, into a mixed signal integrated circuit, a system on a chip (SOC), for example.

The constraint menu 902 includes one or more layout constraints 910. The one or more layout constraints 910 may be standard built-in layout constraints and/or optional user defined layout constraints.

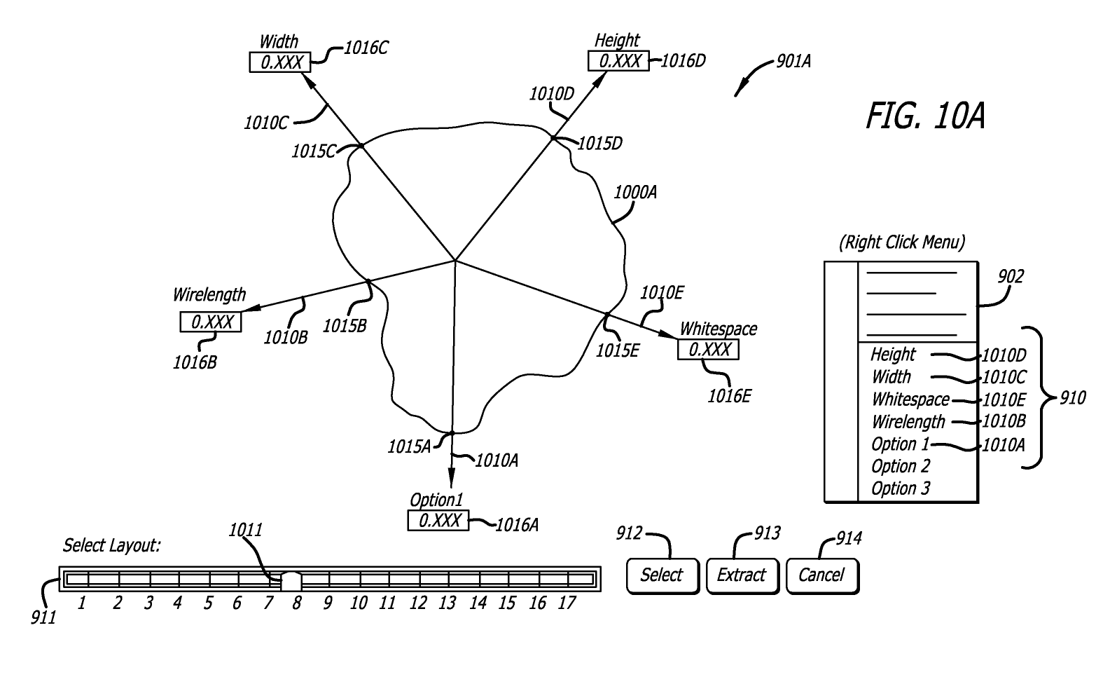

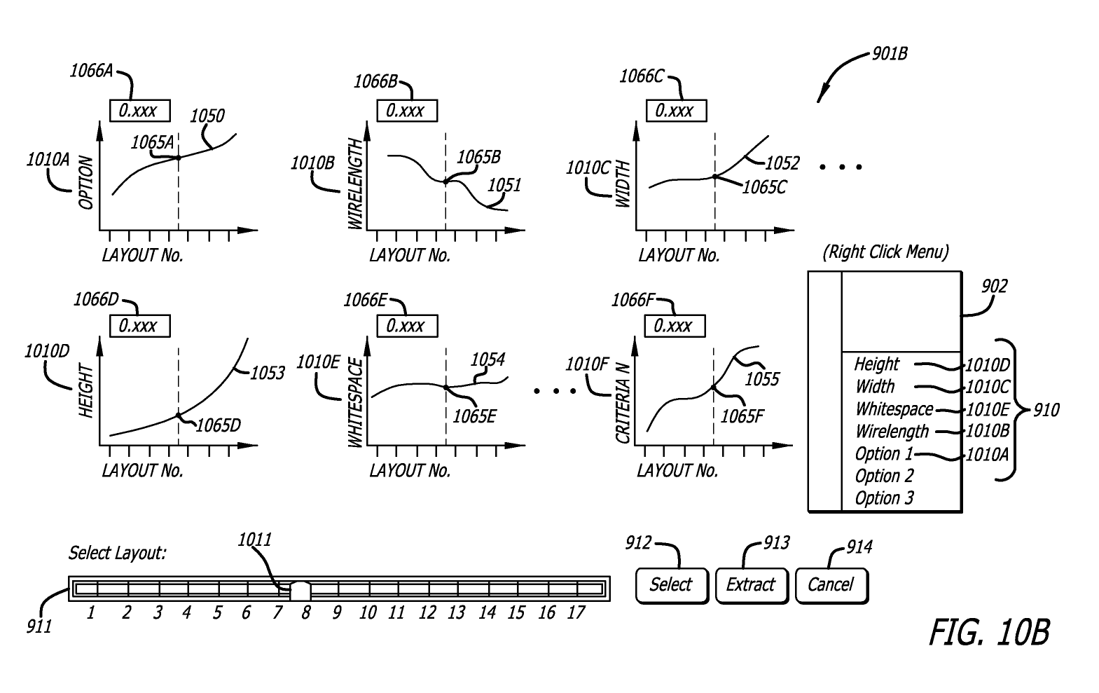

Referring now to FIG. 10A, a multiple dimension plot window 901A is illustrated for layout selection by a user that may be displayed on a computer monitor. The multiple dimension plot window 901A includes a multidimensional plot 1000A over a plurality of layout criteria 1010A-1010E. Each of the plurality of layout criteria 1010A-1010E are listed in the menu 902 which may be accessible to a user by right clicking on a mouse button. The plurality of layout criteria 1010A-1010E may include one or more options, such as option 1 1010A; minimize wire length 1010B; minimize white space 1010E; cell width 1010C; and cell height 1010D.

The plot window 901 offers many layout solutions to a user through a sliding switch 911. The sliding switch 911 is used to select the desired analog layout solution to display. For example, analog layout solution 8 is selected out of 17 possible layout solutions to generate the multidimensional plot 1000A for a given analog circuit layout in the database. As the sliding switch 911 is moved to select another desired analog layout solution, the multidimensional plot 1000A changes to display a different plot for a different analog layout solution.

The multidimensional plot 1000A illustrates how a selected analog layout solution meets each of the plurality of layout criteria 1010A-1010E. For example, in the exemplary multidimensional plot 1000A illustrated in FIG. 10A, the plot 1000A is skewed to indicate that the optional criteria 1010A is being satisfied more than the minimize wire length criteria 1010B. A user may scan through all the layout solutions to select the one that best meets a couple of the layout criteria. Alternatively, a user may scan through all the layout solutions to select one that is more centered to equally meet all the displayed criteria 1010A-1010E.

For a given selected layout solution 1011 selected by the sliding switch 911, the plot window displays maximum criteria points 1015A-1015E that are illustrated at the intersection of the plot 1000A and each of the criteria axes with respective maximum value boxes 1016A-1016E being displayed near the end of each axes.

Referring now to FIG. 10B, a two dimensional plot window 901B is illustrated including a plurality of two dimensional plots 1050-1055 for layout selection by a user that may be displayed on a computer monitor. Each of the plurality of two dimensional plots 1050-1055 are graphed and displayed using the layout number of the analog layout solution on the x-axis versus a given respective criteria 1010A-1010F on the y-axis. That is, each of the plurality of two dimensional plots 1050-1055 illustrates the value for the respective criteria 1010A-1010F for a plurality of analog layout solutions. In this manner, a user can readily select a layout solution that maximizes or minimizes a single or a couple of the criteria 1010A-1010F. A user may slide the sliding switch 911 to select the one analog layout solution that best meets a user's goal for a couple of the layout criteria.

For a given selected layout solution 1011 selected by the sliding switch 911, the two dimensional plots 1050-1055 display criteria points 1065A-1065F with respective value boxes 1066A-1066E being displayed near the top of each y-axis. For example, selected layout number 8 may provide a relative width of 0.5 at point 1065C and a relative height of 0.2 at point 1065D. As a user slides the sliding switch 911, different values for the criteria are displayed.

A plurality of layout criteria may be used to evaluate the plurality of layout solutions, including standard built-in criteria and user customized criteria. The one or more two-dimensional plots 1050-1055 are displayed by selecting the layout criteria through the use of the menu 902.

As previously mentioned, multiple analog layout solutions may be selected by a user to have their layouts of various mask layers displayed.

FIG. 11 illustrates an exemplary schematic diagram of a comparator (COMP) 1100 to explain the plurality of layout choices that are made available to a user. The COMP 1100 is a CMOS comparator and includes p-channel transistors M2-M9; n-channel transistors M10-M11,M13-M15,M17-M22; and an inverter gate G1 coupled together as shown.

Various layout solutions for the COMP 1100 may be selected based on layout criteria previously described. For example, the layout solutions for the COMP 1100 may be selected based on the cell width and cell length of the COMP 1100.

Referring now to FIG. 12, an exemplary shape curve 1200 of a family of layout solutions made available by the embodiments of the invention for the schematic diagram of the COMP 1100 of FIG. 11 is illustrated. The legend indicates a percentage of whitespace. For example, certain points along the curve have a layout solution with 0-10% of whitespace.

Along the x-axis is the cell height of the COMP 1100. Along the y-axis is the cell width of the COMP 1100. For example, a user may select layout solutions 1201, 1202, and 1203 to have their floor-plans be displayed on a monitor to visualize their shapes for inclusion in a level of hierarchy of the integrated circuit. The user selects the desired layouts to view by pressing the select button 912 in the plot window 901.

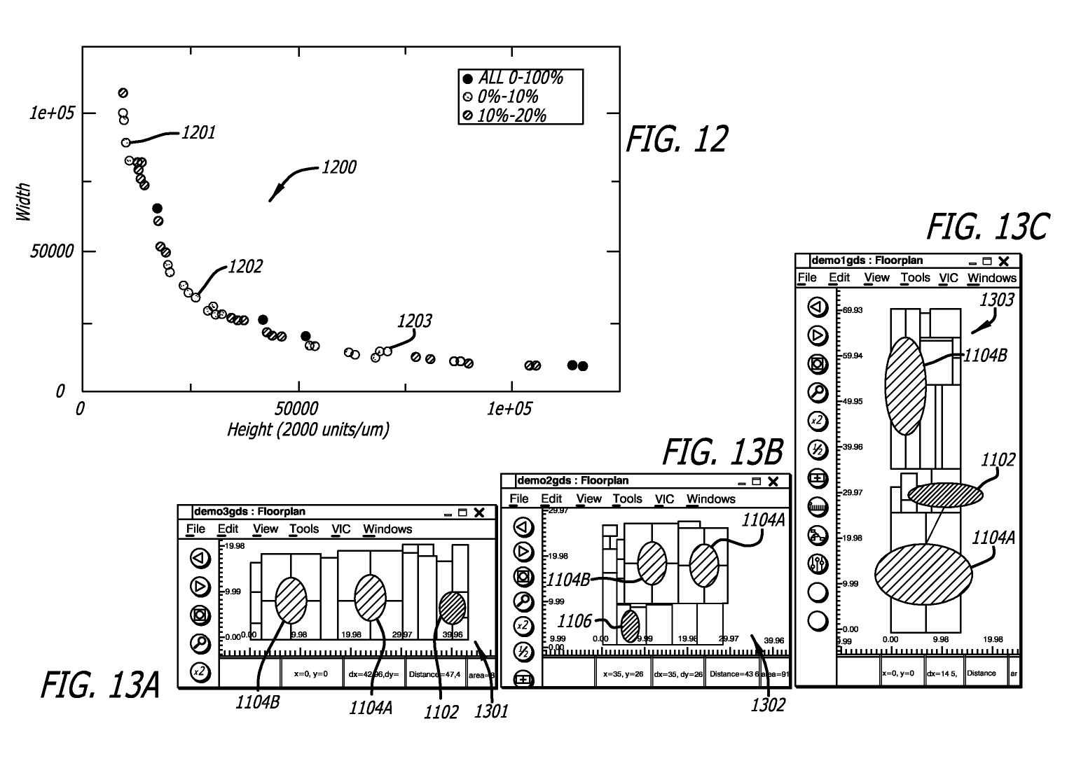

Referring now to FIGS. 13A-13C, three exemplary floor-plans 1301-1303 corresponding to the selected layout solutions 1201-1203, respectively, are made available by the embodiments of the invention for the schematic diagram of the comparator of FIG. 11. The floor plan 1301 approximately has a cell width of 48 units and a cell height of 20 units. In one embodiment of the invention, one unit is one micron. The floor plan 1302 approximately has a cell width of 35 units and a cell height of 30 units. The floor plan 1303 approximately has a cell width of 15 units and a cell height of 70 units. These floor plans may fit in similarly shaped but scaled upper level subcircuits in the integrated circuit chip hierarchy illustrated in FIG. 2.

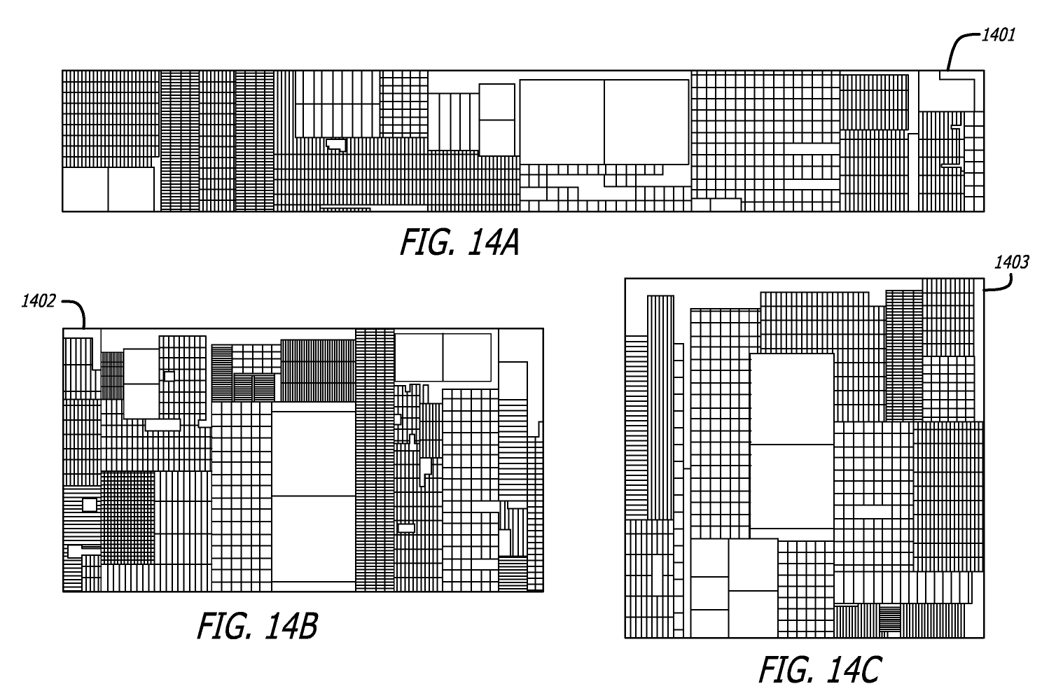

Referring now to FIGS. 14A-14C illustrate three exemplary layouts 1401-1403 out of one hundred-fifty layout solutions that were made available by the embodiments of the invention for the same subcircuit. The three exemplary layouts 1401-1403 may be a filter network. The aspect ratio of the subcircuit height and subcircuit width of the subcircuit layouts 1401-1403 is respectively similar to the aspect ratio of the cell height and cell width of the floor plans 1301-1303 of the standard cell of the comparator 11100.

### Interactive Analog Layout Synthesis

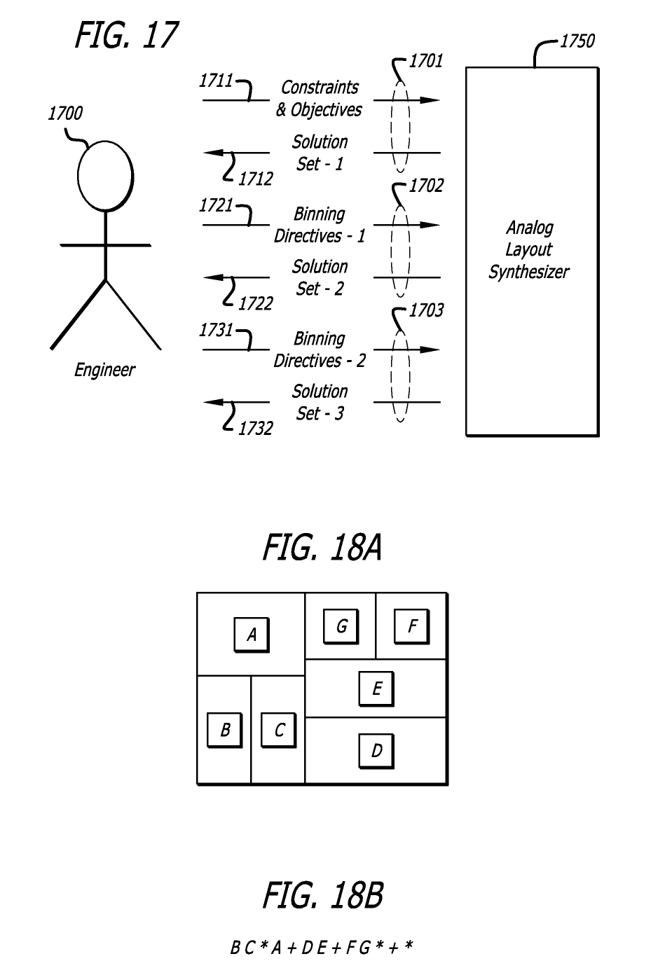

Referring now to FIG. 17, a user transaction diagram is illustrated. A user 1700, such as a circuit design engineer, may iteratively interact with an analog layout synthesizer 1750 over a number of transactions. In some embodiments of the invention, the analog layout synthesizer 1750 is the HALS tool described previously.

For a first transaction 1701, a job or execution run invokes the analog layout synthesizer software 1750. A number of constraints & objectives 1711 of the first transaction 1701 are provided by the user to the analog layout synthesizer software 1750 for the first transaction. A first analog layout solution set 1712 for the first transaction 1701 is generated by the analog layout synthesizer software 1750 and presented to the user 1700. The first analog layout solution set 1712 may be presented to the user 1700 by being displayed by a graphical user interface (GUI) on a display device for example.

The constraints & objectives 1711 (e.g., layout objectives 302 and layout constraints 303 in FIG. 3) are mathematical relationships provided to the Multi-Objective Optimizer 313 of the analog layout synthesizer software 1750. The constraints & objectives 1711 are to be taken into account in generating a first solution set 1712. A user may inspect and review the first layout solution set 1712 synthesized by the analog layout synthesizer 1750 and determine that while it is a “closed” solution meeting the initial expectations (e.g., the constraints and objectives), it would be preferable that the analog layout synthesizer 1750 continue to search for more or better solutions around the previous layout solution set.

Each solution set generated by the analog layout synthesizer software 1750 includes a set of a plurality of analog circuit layouts. Each analog circuit layout may be represented by a layout file, such as an industry-standard layout file format (e.g., GDS file), that can be used to display the layout. With an industry standard file format, each layout can be viewed with a common available viewer, such as a GDS viewer. However, proprietary formats may be used for the layout file as well. In the layout file, each circuit element is labeled with its name and each group of circuit elements can be identified by its bounding box.

Internally, each layout of each solution set may be represented as a layout polish expression of groups or bins of circuit elements. Each bin or group of circuit elements in the layout may also be represented by a polish expression of circuit elements. With the layout of an analog circuit being represented by a layout polish expression, binning directives may be used with the bins to facilitate a further iteration to find a user preferred layout solution.

For example, consider FIG. 18A that illustrates a layout for an analog circuit formed of bins A-G. A bin may be a single device or a group of devices, such as one or more transistors. FIG. 18B illustrates a layout polish expression representation of the layout of the analog circuit of FIG. 18A. The operators * and + combining bins A-G together are the operators in the layout polish expression representation of the layout. Each operand of the layout polish expression is a bin.

Each bin may further have its own polish expression of devices. For example, bin A may have the polish expression “A=M1 M2+”. The layout polish expression may then be written as “B C*(M1 M2*)+D E+F G*+*”.

Referring now back to FIG. 17, after viewing the first set of layout solutions 1712, the user 1700 may find no preferred analog layout solution. The user may want to apply certain preferences as to how the layout should be generated that were not or could not be described as a constraint or an objective. The user may supply one or more first binning directives 1721 to the analog layout synthesizer software 1750 as part of a second transaction 1702. The one or more first binning directives 1721 may be used to update the constraints & objectives 1711 coupled to the analog layout synthesizer 1750. The one or more first binning directives 1721 along with the base constraints & objectives 1711 are taken into account in generating a second layout solution set 1722.

While the second layout solution set 1722 may be generated from scratch, the analog layout synthesizer 1750 can more quickly generate the second layout solution set by starting from the data of the first layout solution set. The user selectively instructs the analog layout synthesizer 1750 through a directive to re-synthesize a layout from prior layout database information instead of synthesizing a layout from the very beginning or scratch. If no directive is given to re-synthesize the analog circuit using the prior layout solutions, the analog layout synthesizer 1750 by default synthesizes a layout from the very beginning or scratch.

After viewing the second layout solution set 1722, the user 1700 may still find no preferred analog layout solution. The user may supply one or more second binning directives 1731 to the analog layout synthesizer software 1750 as part of a third transaction 1703. The one or more second binning directives 1731 may be used to further update the constraints & objectives 1711 coupled into the analog layout synthesizer 1750. The one or more second binning directives 1731 along with the base constraints & objectives 1711 and the one or more first binning directives 1721 may be taken into account in generating a third layout solution set 1732. Alternatively, a user may choose to eliminate the one or more first binning directives 1721 such that the one or more second binning directives 1731 along with the base constraints & objectives 1711 are taken into account in generating the third layout solution set 1732. A user has complete freedom to add, delete, or modify any constraints prior to re-synthesizing.

While the third layout solution set 1732 may be generated from scratch, the analog layout synthesizer 1750 can more quickly generate the second layout solution set by starting from the data of the first and second layout solution sets. The user selectively instructs the analog layout synthesizer 1750 to re-synthesize a layout from prior layout database information instead of synthesizing a layout from the very beginning or scratch. The process of re-synthesizing the analog layout using prior layout solutions may be repeated over and over again to find a preferred layout solution set for a user.

Generally, a directive is an instruction from the user specifying some relationship of a group of one or more circuit elements to form the layout of an analog circuit. A directive may also be referred to as a layout directive as it establishes relationships for the synthesis of a layout. The constraints & objectives 1711 (e.g., layout objectives 302 and layout constraints 303 in FIG. 3) are formed out of different types of directives. A binning directive is a user controlled layout preference to control the layout of a bin or group of one or more elements. A binning directive may specify the elements of one or more bins.

In one embodiment of the invention, a binning directive specifies a list of blocks, devices or circuit elements that are to be grouped as a set having a binName and laid-out closely together to form a layout in one embodiment of the invention.

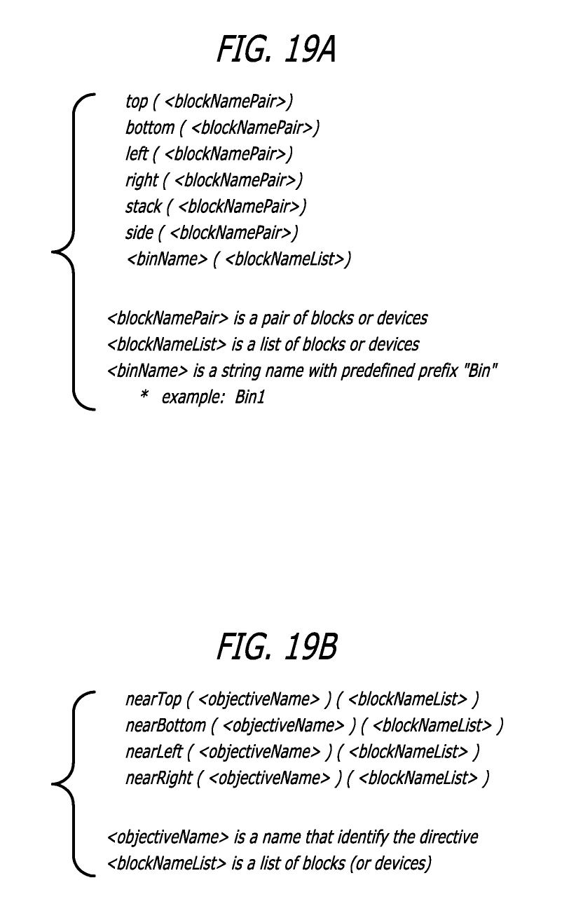

Referring momentarily to FIG. 19A, the bin directive instruction has a format of <binName> (<blockNameList>). The <binName> is a string name with a predefined prefix “Bin” and <blockNameList> is a list of blocks or devices in the binName set. An exemplary binName is Bin1.

Other types of directives may be a different instruction to indicate the relative placement between two or more devices. Other types of directives may be an instruction from the user that specifies a location in the layout where a group of circuit elements may be laid-out in a given layout boundary. In another embodiment of the invention, a directive may an instruction from the user that specifies a group of circuit elements that should be spaced apart from each other to form the layout. In another embodiment of the invention, a custom directive may be formed by a user with instructions for any constraint that can be described mathematically or algorithmically.

The binning directive instruction includes a specification of which devices should be grouped together and optionally a polish expression that explicitly defines their relative placement amongst each other. An exemplary polish expression was described previously with reference to FIGS. 18A-18B.

There are a number of directives available to a user to specify his layout preferences when presented with a first layout solution. A layout preference is a device placement preference in one embodiment of the invention. The directives to specify a user's device placement preference may be categorized into two different categories of directives: (1) directives to specify relative placement between two or more devices, and (2) directives to specify relative device placement within layout boundaries.

Referring now to FIG. 19A, generally the directives to specify relative placement between two or more devices are top, left, right, bottom, side, stack, and/or adjacent, for example. The format of these device to device directives better illustrated in FIG. 19A is top (<blockNamePair>), bottom (<blockNamePair>), left (<blockNamePair>), right (<blockNamePair>), stack (<blockNamePair>), and side (<blockNamePair>). The variable <blockNamePair> is a pair of blocks or devices, such as a first device and a second device.

The top directive specifies the second device is on the top of the first device. The bottom directive specifies the second device is at the bottom of the first device. The left directive specifies the second device is at the left of the first device. The right directive specifies the second device at the right of the first device. The stack directive specifies the second device at the top or bottom of the first device. The side directive specifies the second device at the right or left of the first device. The bin directive is a special device to device placement directive.

Referring now to FIG. 19B, generally the directives to specify a relative device placement within a layout boundary are nearTop, nearBottom, nearLeft, and/or nearRight, for example. The format of these relative device placement directives better illustrated in FIG. 19B is nearTop (<objectiveName>) (<blockNameList>), nearBottom (<objectiveName>) (<blockNameList>), nearLeft (<objectiveName>) (<blockNameList>), and nearRight (<objectiveName>) (<blockNameList>). The variable <objectiveName> is a name that identifies the directive. The variable <blockNameList> is a list of blocks or devices.

The nearTop directive specifies a list of blocks that should be placed as close as possible to the topEdge. The nearBottom directive specifies a list of block that should be placed as close as possible to bottomEdge. The nearLeft directive specifies a list of block that should be placed as close as possible to the leftEdge. The nearRight directive specifies a list of block that should be placed as close as possible to the rightEdge.

Referring now to FIG. 9B, a displayed user interface 900 is illustrated including a plot window 901, an input window 902B, and a navigation window 903 including a list of drives and folders 904. Generally, the plot window 901 and the input window 903 were described previously with respect to FIG. 9A. However, the plot window 901 now displays a layout floor plan of a circuit so that a user may input one or more directives to indicate preferences for the layout of the circuit. Alternatively, a graphic display of the layout may be viewed by a user to write directives.

The input window 902B may be a pop-up window that is selected by a mouse click, for example, and includes an execute button 922. A user enters the desired directives into the input window 902B for his preferences in the layout. A user may also enter a directive (a “prior database directive”) into the input window 902B to instruct the analog layout synthesizer 1750 to use prior database information as the starting point and re-synthesize a selected prior layout solution to search for more or better solutions to it. The prior database directive may indicate one or more prior layout solutions chosen to start from if there are more than one.

After the directives are entered into the input window, the user clicks the execute button 922 to cause the analog layout synthesizer 1750 to synthesize a new layout or re-synthesize a prior layout solution in response to the directives written by the user in the input window.

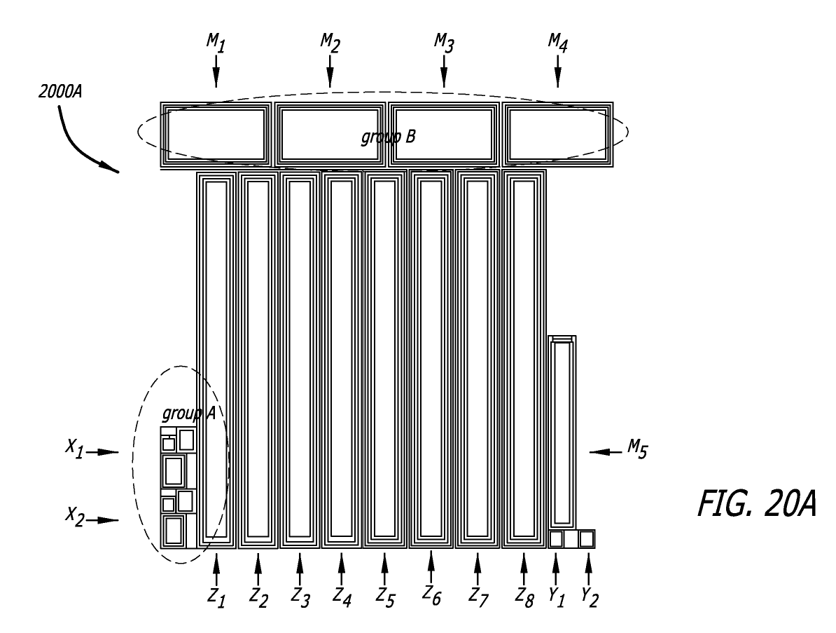

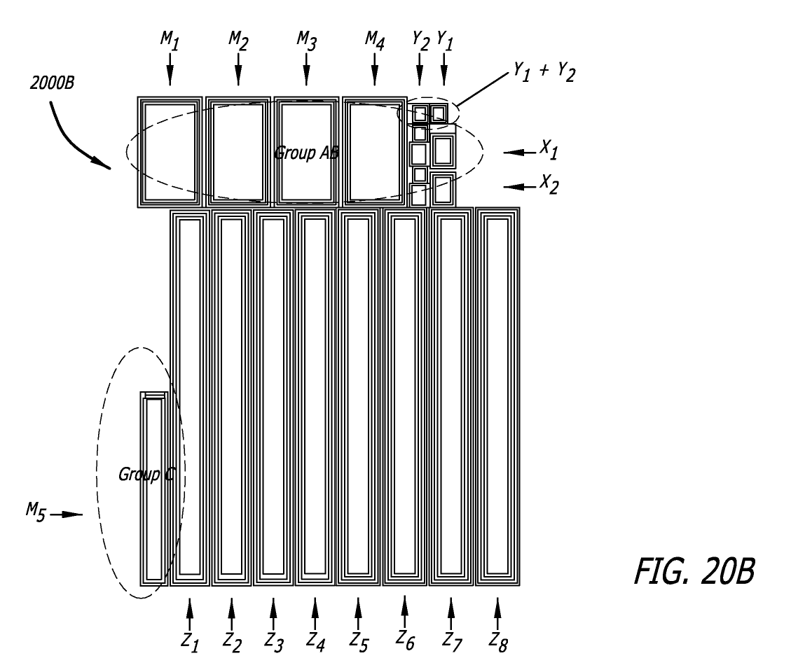

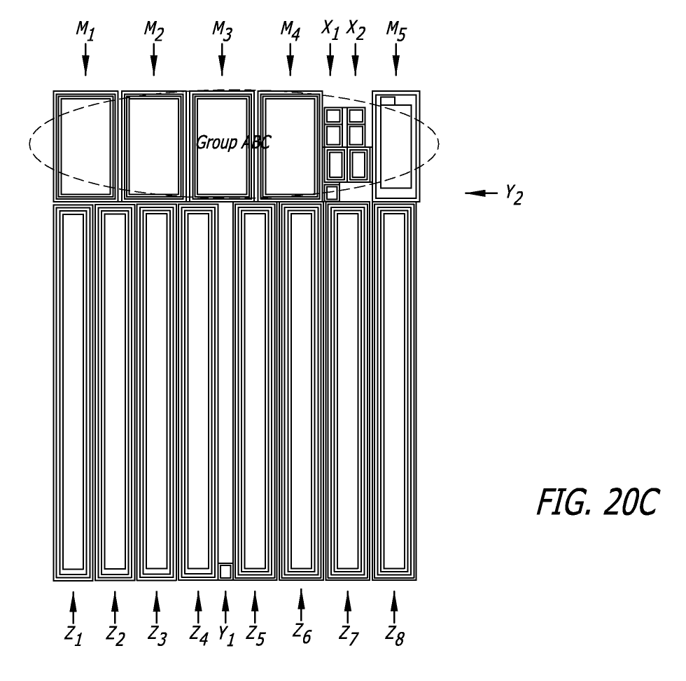

Referring now to FIGS. 20A-20C, first though third analog layout synthesis runs are illustrated with a couple of directives being given to the analog layout synthesis tool 1750 to improve the layout by the re-synthesis process.

In FIG. 20A, a first analog layout synthesis was performed resulting in an analog circuit layout 2000A. After a user sees the first synthesis run, he prefers that transistors X1 and X2 in groupA and transistors M1-M4 in groupB be placed closer to each other. The user generates a bin directive to group together devices from groupA and groupB into a groupAB. An exemplary bin directive may be BingroupAB (X1, X2, M1, M2, M3, M4). The user then requests that the layout 2000A be re-synthesized by the analog layout synthesis tool 1750.

The analog layout synthesis tool 1750 uses the layout 2000A as a starting point in re-synthesizing the layout to speed up the process of obtaining a preferred layout. That is, the analog layout synthesis tool 1750 need not re-synthesize every device or every layer of the transistors X1, X2, M1, M2, M3, M4 or other basic circuit devices. However, it may re-synthesize the interconnect layers (e.g., metal, polysilicon) so that it may re-position, re-orient and reconnect the devices to meet a user's directive. In other cases, polygons on a layer may merged together, or re-shaped in order to re-synthesize a layout to meet a user's directive. For example, well polygons of different devices may be merged together to improve packing density of a layout.

Referring now to FIG. 20B, the re-synthesizing of the layout using the exemplary bin directive of BingroupAB (X1, X2, M1, M2, M3, M4) results in the layout 2000B. The transistors X1, X2, M1, M2, M3, M4 are grouped closely together. To do so, transistors M1-M4 were reoriented and transistors X1, X2 were moved with some device re-orientation. However after seeing the layout 2000B, he may notice that transistor M5 is not laid-out closely to groupAB devices.

A user may desire that transistor M5 be laid-out closely to groupAB devices. In which case, a user may issue another bin directive to group transistor M5 in a groupC to the groupAB devices. An exemplary bin directive may be BingroupABC (M5, BingroupAB). The user then requests that the layout 2000B be re-synthesized by the analog layout synthesis tool 1750.

The analog layout synthesis tool 1750 uses the layout 2000B as a starting point in re-synthesizing the layout to speed up the process of obtaining a preferred layout. Once again, the analog layout synthesis tool 1750 does not need to re-synthesize every device or every layer of the transistors X1, X2, M1, M2, M3, M4, M5 or other basic circuit devices.

Referring now to FIG. 20C, the re-synthesizing of the layout using the exemplary bin directive of BingroupABC (M5, BingroupAB) results in the layout 2000C. The transistors X1, X2, M1, M2, M3, M4, and M5 are now all grouped closely together. In comparing layout 2000B to 2000C, transistors M1-M4 had little to no change. Transistors X1, X2 were moved a little with some device re-orientation. Transistor M5 was moved and re-shaped to change its aspect ratio to fit within the boundaries of the layout all the while maintaining its original electrical length & width. The devices Z1-Z4 and Z5-Z8 are separated slightly to allow the insertion of the device Y1 there-between.

Thus, directives can be used to interactively re-synthesize the layout over and over again to quickly find a preferred analog circuit layout solution. With the layout 2000C of the analog circuit being one that the user prefers, he can save the results and exit the synthesis tool.

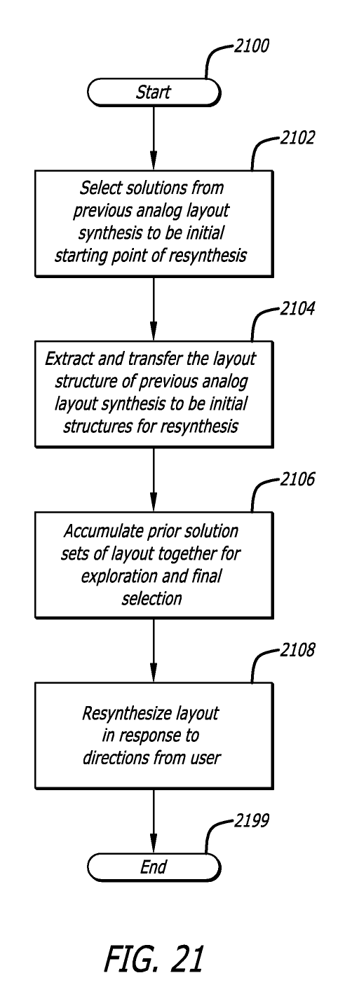

Referring now to FIG. 21, a flow chart of a method for re-synthesis of an analog circuit layout is now described starting at block 2100 which goes to block 2102.

At block 2102, prior layout solutions for a given circuit from previous analog layout synthesis runs are selected to be the initial starting point of re-synthesis of the given circuit instead of starting from scratch.

Then at block 2104, the relevant layout structures from the previous analog layout synthesis runs are extracted and transferred to the current run to be the initial structures for re-synthesis of the layout of the given analog circuit. The current analog layout synthesis run may be logically pointed to the previously synthesized layout structures stored in the database.

Then at block 2106, the prior solution sets of layouts for the given circuit may be accumulated together for exploration and selection by a user to re-synthesize the layout. This may be the case where multiple prior layout solutions were synthesized for the given circuit from which a user may select one or more prior layout solutions as the starting point. This process may be skipped if only one layout solution exits or the most recent solution is to be used.

Then at block 2108, the layout of the given analog circuit is re-synthesized in response to the prior selected layout solutions and the directives provided by a user. After the new layout solution resulting from the re-synthesis is displayed to a user, the process may then end at block 2199. A user may choose to repeat the re-synthesis process in which case the elements of blocks 2102, 2104, 2106, and 2108 may be repeated.

Referring now to FIG. 6B, a flow chart illustrates the process of re-synthesizing and optimizing an analog circuit layout in response to directives in order to provide interactive analog layout synthesis.

The re-synthesis of the layout begins at block 600B and then goes to block 611.

At block 612, one or more directives are received from a user indicating a user preference to re-synthesize the layout. If a bin directive, it indicates the devices that are preferred by a user to be grouped together.

At block 612, the directive is parsed to determine the action to take with the current layout solution. If the directive is a Bin Directive, the devices preferred by a user to be grouped together are put into a single partition or a single smaller subcircuit. If a different directive is parsed, the system performs the operations to satisfy the directive.

As the synthesis tool works starting with a prior synthesized layout stored in a database, there is no need to start from scratch by reading or importing data from the Circuit Netlist Layout Database 512.

Blocks 602B-606 once again perform a hierarchical placement 650 of elements to form an analog circuit layout.

At block 602B, the circuit is partitioned into smaller sub-circuits using a multi-objective evolutionary algorithm (MOEA) or a multi-objective optimization algorithm (MOEA). The MOEA is generally described herein with reference to FIG. 7A and the MOOA is generally described herein with reference to FIG. 7B.

At block 603, sub-circuits are placed within a circuit using MOEA/MOOA criteria. This forms part of the Circuit Pareto Placement Database 610.

At block 604, the ports of the circuit and sub-circuits are placed using the MOEA/MOOA. The port placement also forms part of the Circuit Pareto Placement Database 610.

At block 605, Pareto Layout Solution Data is extracted into internal databases, such as the Circuit Pareto Placement Database 610. This allows other software components of the HALS tool 300 to gain access.

At block 606, the circuit is routed to generate the Circuit Pareto Layout Solution Database 620. During routing by the hierarchical layout component router 315, the hierarchical layout component router 315 may be invoked to change the placement of the subcircuits within a circuit as well as the placement of the ports. That is, if the initial routing was not successful, the process may go back and repeat blocks 603-605 and update the circuit pareto placement database 610. Otherwise if the initial routing was successful, the layout is generated and added to the Circuit Pareto Layout Solution Database 620.

Next at block 607, the Pareto Layout Solutions are exported to the Hierarchical Pareto Layout Solution Database 514 and the layout solution is displayed to a user. The process then goes to block 699 and ends.

In response to viewing the layout solution, a user may desire different or additional directives to further refine the layout towards his preferences without changing the constraints and objectives of the layout. In which case, the process illustrated in FIG. 6B may be repeated.

### Computer System

Referring now to FIG. 15, a computing system 1500 is illustrated that may be used to perform some or all of the processes in accordance with a number of embodiments of the invention. In one embodiment of the invention, the computing system 1500 includes a processor 1510, a memory 1520, a removable media drive 1530, and a hard disk drive 1540. In one embodiment, the processor 1510 executes instructions residing on a machine-readable medium, such as the hard disk drive 1540, a removable medium 1501 (e.g., an optical medium (compact disk (CD), digital video disk (DVD), etc.), a magnetic medium (magnetic disk, a magnetic tape, etc.), or a combination of both. The instructions may be loaded from the machine-readable medium into the memory 1520, which may include Random Access Memory (RAM), dynamic RAM (DRAM), etc. The processor 1510 may retrieve the instructions from the memory 1520 and execute the instructions to perform the operations described above.

Note that any or all of the components and the associated hardware illustrated in FIG. 15 may be used in various embodiments of the system 1500. However, it should be appreciated that other configurations of the system 1500 may include more or less devices than those shown in FIG. 15.

Some portions of the preceding detailed description have been presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The embodiments of the invention also relate to an apparatus for performing the operations described herein. This apparatus may be specially constructed for the required purposes, or it may comprise a general-purpose computer selectively activated or reconfigured by a computer program stored in the computer. Such a computer program may be stored in a computer readable storage medium, a processor readable medium, a machine-readable medium, or any other mechanism or medium for storing or transmitting information in a form readable by a machine (e.g., a computer), such as, but is not limited to, any type of disk including magnetic disk storage media; optical storage media; floppy disks, optical disks, CD-ROMs, and magnetic-optical disks, read-only memories (ROMs), random access memories (RAMs), EPROMs, EEPROMs, flash memory devices, magnetic or optical cards, or any type of media suitable for storing electronic instructions, and each of which may be coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will appear from the description below. In addition, the embodiments of the invention are not described with reference to any particular programming language. It will be appreciated that a variety of programming languages may be used to implement the teachings of the invention as described herein.

### CONCLUSION

The hierarchical analog layout synthesizer (HALS) can interactively re-synthesize the physical layout design of analog circuits in response to user supplied preferences provided through directives. By starting with prior layout solutions, the layout can be re-synthesized more quickly than starting from scratch. The re-synthesis can be repeated over and over with new directives in order to converge to a set of layout solutions that a user prefers.

The embodiments of the invention, when implemented in software, include elements that are essentially the code segments to automatically perform the necessary tasks. The program or code segments can be stored in a processor readable medium or transmitted by a computer data signal embodied in a carrier wave over a transmission medium or communication link. The program or code segments may be downloaded via computer networks such as the Internet, Intranet, etc.

The embodiments of the invention are thus described. While certain exemplary embodiments have been described and shown in the accompanying drawings, it is to be understood that such embodiments are merely illustrative of and not restrictive on the broad invention, and that the embodiments of the invention not be limited to the specific constructions and arrangements shown and described, since various other modifications may occur to those ordinarily skilled in the art.

1-39. (canceled)

40. A method for integrated circuit design, the method comprising:
synthesizing an analog integrated circuit design to generate a first layout solution;
receiving a first directive indicating a user preference to improve upon the first layout solution;
re-synthesizing the analog integrated circuit design using the first layout solution as a starting point to generate a second layout solution responsive to the first directive.

41. The method of claim 40, further comprising:
receiving a second directive indicating a user preference to improve upon the second layout solution;
re-synthesizing the analog integrated circuit design using the first and second layout solutions as the starting point to generate a third layout solution responsive to the first directive and the second directive.

42. The method of claim 40, further comprising:
receiving a second directive indicating a user preference to improve upon the second layout solution;
re-synthesizing the analog integrated circuit design using the second layout solution as the starting point to generate a third layout solution responsive to the first directive and the second directive.

43. The method of claim 40, further comprising:
receiving a second directive indicating a user preference to improve upon the second layout solution;
re-synthesizing the analog integrated circuit design using the first layout solution as the starting point to generate a third layout solution responsive to the first directive and the second directive.

44. The method of claim 40, further comprising:
receiving a second directive indicating a user preference to improve upon the second layout solution;
re-synthesizing the analog integrated circuit design using the first and second layout solutions as the starting point to generate a third layout solution responsive to the second directive but not the first directive.

45. An apparatus for re-synthesizing a layout of analog circuitry, the apparatus comprising:
a means to select a mode in which one or more prior layout solution sets from one or more previous analog layout synthesis runs are used as an initial starting point for a new analog layout synthesis run;
a means of extracting and transferring layout structures from one or more layout solution sets of previous analog layout synthesis runs into a set of initial layout structures for the new analog layout synthesis run; and
a means of accumulating substantially all layout solution sets from previous analog layout synthesis runs and making them available for exploration and final selection by a user.

46. The apparatus of claim 45, further comprising:
a means to allow selection of a layout solution set for the analog circuitry by the user.

47. An apparatus comprising:
a machine readable medium including instructions stored therein, the instructions stored on the machine readable medium include
instructions to synthesize an analog integrated circuit design to generate a first layout solution in response to one or more constraints or objectives;
instructions to receive a first binning directive for one or more bins of circuit elements indicating a first user preference to improve upon the first layout solution; and
instructions to re-synthesize the analog integrated circuit design to generate a second layout solution in response to the first layout solution and the first binning directive.

48. The apparatus of claim 47, wherein
the instructions stored on the machine readable medium include
instructions to receive a second binning directive for the one or more bins of circuit elements indicating a second user preference to improve upon the second layout solution; and
instructions to re-synthesize the analog integrated circuit design to generate a third layout solution in response to the first layout solution, the second layout solution, or the first and second layout solutions and the first binning directive, the second binning directive, or the first and second binning directives.

49. The apparatus of claim 47, wherein
the instructions stored on the machine readable medium include
instructions to display each layout solution to the user on a display device.

50. The apparatus of claim 47, wherein
each layout solution is represented by a layout polish expression of one or more bins of circuit elements.
